(19) United States
(12) Patent Application Publication
(10) Pub. No.: US 2025/0222655 A1
(43) Pub. Date: Jul. 10, 2025

(54) PREDICTING MANUFACTURING OUTCOMES FOR ADDITIVELY MANUFACTURED OBJECTS

(71) Applicant: Align Technology, Inc., San Jose, CA (US)

(72) Inventors: Xirui Peng, Apex, NC (US); Yuxiang Wang, Newark, CA (US); Kangning Su, Pullman, WA (US); Viswanath Meenakshisundaram, Santa Clara, CA (US); Jun Sato, San Jose, CA (US)

(21) Appl. No.: 19/009,545

(22) Filed: Jan. 3, 2025

Related U.S. Application Data
(60) Provisional application No. 63/617,694, filed on Jan. 4, 2024.

(51) Int. Cl. B29C 64/386; B29L 31/00; B33Y 50/00; B33Y 80/00; G05B 13/02

(52) U.S. Cl. CPC B29C 64/386; B33Y 50/00; B33Y 80/00; G05B 13/027; B29L 2031/753

(57) ABSTRACT

Methods and systems for predicting manufacturing outcomes are provided. In some embodiments, a method includes receiving at least one image representing a target geometry of an object to be fabricated using an additive manufacturing process. The method can include generating at least one modified image by inputting the at least one image into a machine learning algorithm. The machine learning algorithm can be trained to determine one or more modifications to the at least one image, where the one or modifications are configured to compensate for predicted deviations from the target geometry of the object when the object is fabricated via the additive manufacturing process based on the at least one image. The method can further include generating instructions for fabricating the object using the additive manufacturing process, based on the at least one modified image.

### CROSS-REFERENCE TO RELATED APPLICATION(S)

The present application claims the benefit of priority to U.S. Provisional Application No. 63/617,649, filed Jan. 4, 2024, which is incorporated by reference herein in its entirety.

### TECHNICAL FIELD

The present technology generally relates to additive manufacturing, and in particular, to predicting manufacturing outcomes for additively manufactured objects.

### BACKGROUND

Additive manufacturing encompasses a variety of technologies that involve building up 3D objects from multiple layers of material. Typically, the manufacturing process involves creating a digital model of an object, converting the model into a series of slices, then sequentially printing the slices to build up the object in a layer-by-layer manner. However, the actual geometry of the printed object may not match the initial object design. For example, issues such as overcuring and resin contamination in vat polymerization processes may affect the dimensional accuracy of the resulting printed object. Moreover, post-processing conditions as centrifugation forces, heating, and solvent washes may cause warping of the object geometry. Deviations between the actual and intended geometry of the object may detrimentally affect the function and properties of the printed object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIG. 3 is a block diagram providing a general overview of a workflow for additive manufacturing of objects, in accordance with embodiments of the present technology.

FIG. 4 is a flow diagram illustrating a method for generating instructions for additive manufacturing of an object, in accordance with embodiments of the present technology.

FIG. 5 is a block diagram illustrating a prediction algorithm for predicting manufacturing outcomes, in accordance with embodiments of the present technology.

FIGS. 6A-6C illustrate determination of an experimentally calibrated threshold for filtering predicted images, in accordance with embodiments of the present technology.

FIG. 7 is a schematic illustration of a divide and conquer approach, in accordance with embodiments of the present technology.

FIG. 8 is a block diagram illustrating an optimization algorithm for generating modified images, in accordance with embodiments of the present technology.

FIGS. 9A-9C are schematic illustrations of an inverse optimization process for modifying a geometry of an object, in accordance with embodiments of the present technology.

FIG. 10 is a block diagram illustrating a workflow for generating instructions for additive manufacturing of an object, in accordance with embodiments of the present technology.

FIG. 11 is a block diagram illustrating a workflow for training a surrogate algorithm, in accordance with embodiments of the present technology.

FIG. 12 is a flow diagram illustrating a method for generating instructions for additive manufacturing of an object, in accordance with embodiments of the present technology.

FIG. 13 is a flow diagram illustrating a workflow for evaluating a modified image of an object, in accordance with embodiments of the present technology.

FIG. 14 is a block diagram illustrating a workflow for training a reverse algorithm, in accordance with embodiments of the present technology.

FIG. 15A illustrates a representative example of a tooth repositioning appliance configured in accordance with embodiments of the present technology.

FIG. 15B illustrates a tooth repositioning system including a plurality of appliances, in accordance with embodiments of the present technology.

FIG. 15C illustrates a method of orthodontic treatment using a plurality of appliances, in accordance with embodiments of the present technology.

FIG. 16 illustrates a method for designing an orthodontic appliance, in accordance with embodiments of the present technology.

FIG. 17 illustrates a method for digitally planning an orthodontic treatment and/or design or fabrication of an appliance, in accordance with embodiments of the present technology.

### DETAILED DESCRIPTION

The present technology relates to methods and systems for additive manufacturing of objects, such as dental appliances. In some embodiments, for example, the present technology provides a method including receiving at least one image representing a target geometry of an object to be fabricated using an additive manufacturing process. The method can include generating at least one modified image by inputting the at least one image into a machine learning algorithm. The machine learning algorithm can be trained to determine one or more modifications to the at least one image, where the one or modifications are configured to compensate for predicted deviations from the target geometry of the object when the object is fabricated via the additive manufacturing process based on the at least one image. For example, the machine learning can be a convolutional neural network that is trained on initial and optimized object images to predict how to modify the image so that the actual printed object geometry conforms more closely to the target geometry. The method can further include generating instructions for fabricating the object using the additive manufacturing process, based on the at least one modified image.

As another example, the present technology can provide a method including receiving at least one image representing a target geometry of an object to be fabricated using an additive manufacturing process. The method can include determining a predicted geometry of the object after fabrication, based on the at least one image. For example, the predicted geometry can be determined using a machine learning algorithm, such as a convolutional neural network that receives the at least one image as input, and generates at least one output image representing the predicted geometry of the object. The method can also include identifying a deviation between the target geometry and the predicted geometry, and modifying the at least one image based on the identified deviation. The method can further include generating instructions for fabricating the object using the additive manufacturing process, based on the at least one modified image.

The present technology can provide many advantages compared to conventional methods for additive manufacturing of objects. For instance, conventional methods may simply instruct the additive manufacturing system to print the object as designed, without considering deviations in the geometry that may occur during additive manufacturing and/or post-processing of the object. If the deviations are significant and/or occur at important portions of the object, the object may be unsuitable for its intended function. For instance, dimensional inaccuracies may affect the ability of a dental appliance to fit properly on and/or accurately apply forces to the teeth. The methods and systems disclosed herein can overcome these and other challenges by predicting how the geometry of an object may deviate from its intended geometry during additive manufacturing and/or post-processing, and by adjusting the instructions sent to the additive manufacturing system to compensate for the predicted deviations (“deviation prediction and compensation”). The predictions can be made with a high degree of accuracy, even for objects with customized (e.g., patient-specific) geometries. Accordingly, the approaches herein can improve manufacturing outcomes, particularly for objects requiring highly precise and/or highly variable shapes, as well as reduce time and materials wasted in reprinting objects that do not meet accuracy standards. Moreover, the approaches herein can be applied to many different types of additive manufacturing processes and post-processing operations.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Prediction of Additive Manufacturing Outcomes

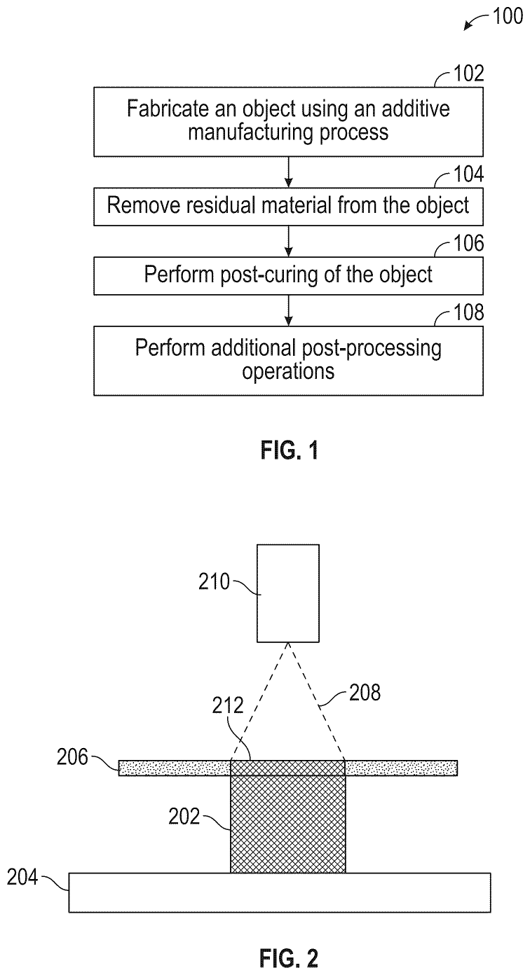

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The method 100 begins at block 102 with fabricating an object using an additive manufacturing process. The additive manufacturing process can implement any suitable technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stercolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing residual material from the object, performing post-curing of the object, and/or additional post-processing operations.

For example, at block 104, the method 100 can continue with removing residual material from the object. The excess material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 106, the method 100 can optionally include post-curing the object. Post-curing is an additional curing process that can be used in situations where the object is still in a partially cured “green” state after fabrication. For example, the energy used to fabricate the object in block 102 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object. Post-curing can be performed by heating the object, applying radiation (e.g., UV, visible, microwave) to the object, or suitable combinations thereof. In other embodiments, however, the post-curing process of block 106 is optional and can be omitted.

At block 108, the method 100 can include one or more additional post-processing operations, such as removing sacrificial components that are not intended to be part of the final object (e.g., support structures), cleaning the object (e.g., washing, solvent extraction), annealing the object, separating the object from a build platform, performing surface modifications and/or treatments, and/or packaging the object for shipment.

The method 100 illustrated in FIG. 1 can be modified in many different ways. For example, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied. Some of the processes of the method 100 can be omitted, and/or the method 100 can include additional processes not shown in FIG. 1.

FIG. 2 is a partially schematic diagram providing a general overview of an additive manufacturing process, in accordance with embodiments of the present technology. As shown in FIG. 2, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

Deviations between the intended and actual geometry of an object may occur during additive manufacturing and/or post-processing. For instance, overbuild and/or overcure can occur when the precursor material used to form the object is cured to a greater extent than intended in the horizontal (e.g., x and y) dimension and/or the vertical (e.g., z) dimension, respectively, thus causing the actual geometry of the cured object portion (e.g., area and/or height) to be larger than the intended geometry. As another example, excess material that is not completely removed from the object can become incorporated into the object during post-processing, thereby altering the object geometry. It may be difficult to completely remove highly viscous materials (e.g., resins) from the object after fabrication, and/or material may become trapped on or within the object depending on the local geometry (e.g., material may collect at object portions having high curvature, such as holes, corners, recesses, cavities, etc.). As yet another example, the object may deform due to mechanical stresses, temperatures, solvents, and/or other conditions during additive manufacturing and/or post-processing. In some instances, large centrifugation forces are used to remove highly viscous resins from the object, which may result in flaring, warping, and/or other deformations, particularly at portions of the object that are relatively thin. As a further example, material can be lost from one or more portions of an object due to solvents, mechanical abrasion, and/or other conditions during additive manufacturing and/or post-processing.

Deviations between the intended and actual geometry of an object may compromise the function and properties of the object. For example, certain types of dental appliances may have small and/or detailed features with strict manufacturing tolerances. Regions of the dental appliance that are important or necessary for certain functions (e.g., clinical efficacy, proper positioning, ergonomics, mechanical properties, aesthetics) may also be subject to strict tolerances. For example, the tolerance for certain features and/or regions of a dental appliance can be less than or equal to 500 μm, 200 μm, 100 μm, 50 μm, 20 μm, or 10 μm. If the actual size, shape, and/or location of the features and/or regions deviate significantly from the intended size, shape, and/or location (e.g., the deviation exceeds the tolerance), the appliance may be unsuitable for its intended function, e.g., the appliance may not fit properly on the teeth and/or may fail to apply the correct forces to the teeth.

To address these and other challenges, the present technology provides methods for predicting the geometry of an object after additive manufacturing and/or post-processing. For instance, the methods herein can be used to predict the object geometry that will result after additive manufacturing and/or post-processing (e.g., using a prediction algorithm such as a machine learning algorithm). The predicted geometry can then be compared to the target geometry to determine whether there are significant deviations. If significant deviations are detected, the method can modify the instructions that are sent to the additive manufacturing system (e.g., using an optimization algorithm) so that the actual geometry of the object that is produced conforms more closely to the target geometry.

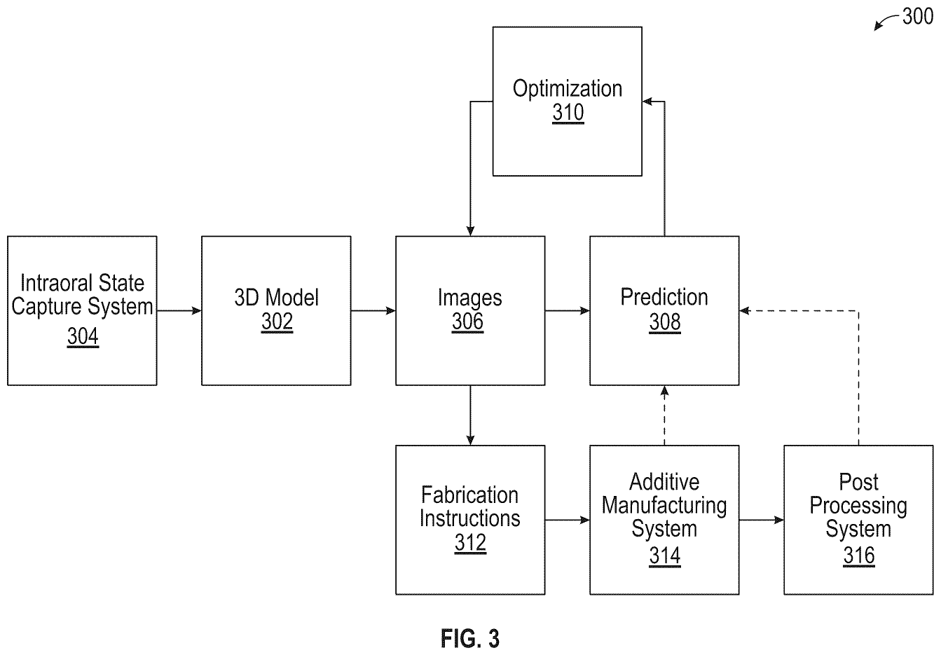

FIG. 3 is a block diagram providing a general overview of a workflow 300 for additive manufacturing of objects, in accordance with embodiments of the present technology. The workflow 300 can begin with receiving and/or generating a 3D model of an object to be fabricated via an additive manufacturing process (block 302). The 3D model can be any digital representation of the target 3D geometry of the object, such as a surface model, mesh model, parametric model, non-parametric model, etc. The 3D model can be provided in any suitable file format, such as a CAD file, STL file, OBJ file, AMF file, 3MF file, etc.

In embodiments where the object is a dental appliance, the 3D model of the dental appliance can be generated using a computing system or device that implements software for designing appliances in accordance with a treatment plan. The appliance can be designed based on a treatment prescription received from a clinician and data of a patient's teeth received from an intraoral state capture system (block 304). The intraoral state capture system can be configured to obtain sensor data of a patient's dentition, intraoral cavity, and/or other relevant anatomical structures (e.g., craniofacial anatomy). The sensor data can depict the patient's dentition in any suitable arrangement, such as an initial arrangement before the start of a treatment plan, an intermediate arrangement after treatment has commenced, or a final arrangement after the treatment has been completed. The sensor data can be generated via any suitable modality, and can include photographs, videos, scan data (e.g., intraoral and/or extraoral scans), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), and/or motion data. The sensor data can include 2D data (e.g., 2D photographs or videos), 3D data (e.g., 3D photographs, intraoral and/or extraoral scans, digital models), 4D data (e.g., fluoroscopy data, dynamic articulation data, hard and/or soft tissue motion capture data), or suitable combinations thereof.

In some embodiments, for example, the intraoral state capture system includes or is operably coupled to a scanner configured to obtain a 3D digital representation (e.g., images, surface topography data) of a patient's teeth, such as via direct intraoral scanning or indirectly via casts, impressions, models, etc. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc., the 3M True Definition Scanner, and the Cerec Omnicam manufactured by Sirona®

In other embodiments (e.g., if the object to be fabricated is a not a dental appliance), the intraoral state capture system is optional and can be omitted from the workflow 300.

The 3D model of the object can be used to generate a plurality of images (block 306). Such images may be referred to herein as “slices,” and the process of generating slices from the 3D model may be referred to herein as “slicing.” The images can represent a plurality of cross-sections (e.g., layers) of the object for fabrication via a layer-by-layer additive manufacturing process. The layer-by-layer additive manufacturing process can include any of the techniques described herein. For example, the layer-by-layer additive manufacturing process can involve using energy to cure a resin in a layer-by-layer manner to form an object, such as DLP or SLA. As another example, the layer-by-layer additive manufacturing process can involve using energy to fuse a powder in a layer-by-layer manner to form the object, such as SLS. The images can be any 2D digital representation suitable for use in generating instructions for controlling application of energy to a precursor material (e.g., resin or powder) to fabricate the object, according to the layer-by-layer additive manufacturing process. For instance, each pixel of the image can represent a corresponding voxel of a respective cross-section of the object, with the pixel value indicating whether the corresponding voxel is part of the object and thus energy should be applied to solidify the precursor material at that voxel, or whether the corresponding voxel is empty space and thus the precursor material should remain unsolidified at that voxel. The images can be provided in any suitable file format, such as a BMP file or a PNG file.

In some embodiments, the slicing process involves determining the locations of a plurality of slicing planes along the 3D model. For instance, the slicing planes can be spaced apart from each other at a plurality of different vertical locations (e.g., z-positions) along the 3D model. The images can then be generated from the 2D cross-sectional geometry of the 3D model at each slicing plane. The slicing process can be based on the specific parameters of the additive manufacturing system (block 314) to be used to fabricate the object. For example, the spacing between the slicing planes (e.g., the slice height or thickness) can be at least the minimum layer height of the additive manufacturing system.

The workflow 300 can include generating a prediction of the object geometry after manufacturing, based on some or all of the images (block 308). As indicated by the broken arrows, the prediction can be a digital representation of the expected geometry of the object after fabrication by the additive manufacturing system (block 314) and/or after processing by a post-processing system (block 316), and thus can account for the particular process types, parameters, conditions, etc., associated with these systems. For example, the prediction can be or include one or more images representing the predicted geometry of each cross-section (e.g., layer) of the object. Alternatively or in combination, the prediction can be or include a 3D model representing the overall 3D geometry of the object, which may be generated by combining the images or may be generated independently of the images.

In some embodiments, the prediction of the object geometry is generated using a software prediction algorithm that receives an input data set including one or more of the images of block 306, and produces an output data set including a digital representation of the predicted geometry of one or more corresponding object cross-sections. The output data set can include, for example, one or more images depicting the predicted geometry of a plurality of cross-sections of the object, a 3D model depicting the predicted overall geometry of the object, or a combination thereof. In some embodiments, the prediction algorithm is or includes a machine learning algorithm (e.g., a convolutional neural network) that has been trained to generate predictions of an object geometry after manufacturing, based on input images corresponding to the instructions provided to the additive manufacturing system for fabricating the object.

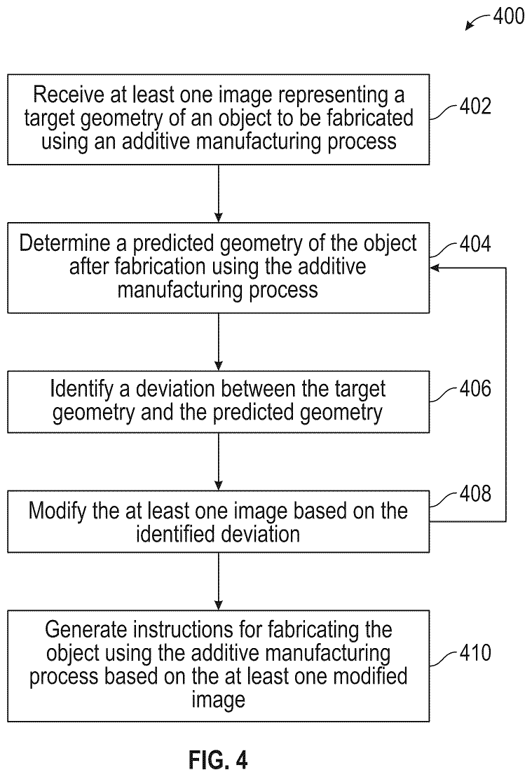

The prediction algorithm can be customized to the particular additive manufacturing process implemented by the additive manufacturing system (block 314) and/or the particular post-processing operations implemented by the post-processing system (block 316). For example, the prediction algorithm can account for some or all of the following conditions and/or parameters associated with additive manufacturing and/or post-processing: the type of additive manufacturing process (e.g., DLP, SLA, SLS), printing parameters of the additive manufacturing system (e.g., curing time, grayscale level, printing speed, light intensity, minimum feature size, minimum layer height, print resolution, print unit shape, print directionality, print offset, an expected amount of overcuring and/or overbuild), properties of the precursor material used to fabricate the object (e.g., viscosity, optical properties, light transmittance, light scattering), and/or post-processing conditions (e.g., conditions due to centrifuging, washing, post-curing, etc., such as temperature, applied forces, exposure to solvents and/or other chemicals, etc.). The prediction algorithm can be customized via the design of the functions used by the prediction algorithm and/or training of the prediction algorithm. Additional details and examples of prediction algorithms that may be used are described below, e.g., in connection with FIGS. 4-8.

Subsequently, the predicted geometry can be compared to the target geometry to determine the predicted manufacturing accuracy, e.g., whether any deviations between the predicted and target geometry are present. For example, in embodiments where the prediction includes one or more images depicting the predicted geometry (“predicted images” or “predicted slices”), the predicted images can be compared to one or more of the images generated from the 3D model in block 306 (“initial images” or “initial slices”) to identify the location and extent of the deviations. As described herein, the deviations between the predicted and target geometry may be attributable to conditions during additive manufacturing and/or post-processing, such as overbuild, overcure, excess material on the object, deformation, loss of material, etc.

If the identified deviations are sufficiently large and/or occur at important portions of the object (e.g., portions of a dental appliance that apply forces to teeth), an optimization algorithm can be used to modify some or all of the images to reduce, prevent, or otherwise mitigate the deviations (block 310). The modification can be configured to improve manufacturing accuracy by reducing the deviation between the target geometry of the object and the predicted geometry of the object after manufacturing. For instance, the modification can change the size, shape, and/or location of some or all of the object cross-sections represented in the images, such that an object fabricated based on the modified images more closely resembles the target geometry than an object manufactured based on the initial images. Additional details and examples of optimization algorithms that may be used are described below, e.g., in connection with FIGS. 4-8.

The output of the optimization algorithm can be one or more modified images (block 306) that are then input into the prediction algorithm (block 308) to generate an updated prediction of the object geometry after manufacturing. The updated prediction can then be analyzed to determine whether the predicted manufacturing accuracy is acceptable, e.g., whether deviations between the predicted and target geometry are still present. For instance, one or more predicted images representing the updated prediction can be compared to one or more initial images to identify the location and extent of the deviations. If significant deviations are still present, the optimization routine can be performed again to further modify the images to reduce, prevent, or otherwise mitigate the deviations (block 310). This process can be repeated to iteratively modify the images until the predicted manufacturing accuracy is satisfactory (e.g., the predicted deviations are sufficiently small and/or do not occur at important portions of the object).

The images resulting from the optimization routine can be used to generate fabrication instructions (block 312) for controlling the additive manufacturing system to form the object (block 314). As described herein, the additive manufacturing system can be configured to apply energy to a precursor material (e.g., a resin or powder) to cure, polymerize, melt, sinter, fuse, or otherwise solidify the precursor material into an individual cross-section (e.g., layer) of the object. The energy can be applied according to the data in the corresponding image for that cross-section. For instance, the pixel value at a particular location in an image can indicate whether energy should be applied to a corresponding voxel in the precursor material to form a portion of the object, and, optionally, the parameters of the energy to be applied to that location (e.g., intensity, exposure time, dosage, wavelength). In some embodiments, the images are black and white images, with white pixels indicating that energy should be applied and black pixels indicating that energy should not be applied, or vice-versa. In other embodiments, the images can be grayscale images, with the grayscale values of the pixels corresponding to the desired energy dosage (e.g., intensity and/or exposure time) to be applied. Grayscale images can be used, for example, if the object is intended to have heterogenous properties (e.g., varying degrees of curing may produce variations in properties such as modulus, glass transition temperature, etc.). The fabrication instructions can be any data type that can be used by the additive manufacturing system for fabricating the object. For example, the fabrication instructions can include the images, and/or can include other data generated based on the images, such as a toolpath file (e.g., G-code file).

The fabrication instructions can be transmitted to the additive manufacturing system to cause the object to be fabricated (block 314). The additive manufacturing system can include an energy source (e.g., a laser, projector, light engine), a source of a precursor material (e.g., a vat, carrier film, powder bed), and/or other devices configured to perform the various additive manufacturing processes described herein. Optionally, after fabrication, the object can be transferred to the post-processing system for post-processing (block 316). For example, the post-processing system can include one or more centrifuges, solvent baths, post-curing and/or annealing ovens, trimming systems, and/or other devices configured to perform the various post-processing operations described herein.

The various elements of the workflow 300 can be implemented using any suitable combination of hardware and software components. For example, the intraoral state capture system (block 304), additive manufacturing system (block 314), and post-processing system (block 316) can each include a computing system or device (e.g., a controller) having one or more processors and memory configured to control respective hardware components (e.g., a scanner, printer assembly, or post-processing devices, respectively) to perform the various operations described herein. The 3D model (block 302), images (block 306), prediction algorithm (block 308), optimization algorithm (block 310), and fabrication instructions (block 312) can be generated and/or implemented by software components of one or more computing systems (e.g., a treatment planning system and/or an appliance design system). Some or all of the systems of the workflow 300 can be implemented as a distributed “cloud” server across any suitable combination of hardware and/or virtual computing resources. The various systems of the workflow 300 can communicate with each other via one or more communication networks, such as a wired network, a wireless network, a metropolitan area network (MAN), a local area network (LAN), a wide area network (WAN), a virtual local area network (VLAN), an internet, an extranet, an intranet, and/or any other suitable type of network or combinations thereof.

The configuration of the workflow 300 illustrated in FIG. 3 can be varied in many ways. For example, any of the components of the workflow 300 shown as distinct components in FIG. 3 can be combined and/or include interrelated code. Any of the components of the workflow 300 can be implemented as a single and/or interrelated piece of software, or as different pieces of software. Any of the components of the workflow 300 can be embodied on a single machine or any combination of multiple machines. Some of the components of the workflow 300 can be omitted (e.g., the intraoral state capture system, the post-processing system), and/or the workflow 300 can include additional components not shown in FIG. 3.

FIG. 4 is a flow diagram illustrating a method 400 for generating instructions for additive manufacturing of an object, in accordance with embodiments of the present technology. The method 400 can be used to produce fabrication instructions for any of the objects described herein, such one or more dental appliances. In some embodiments, some or all of the processes of the method 400 are implemented as computer-readable instructions (e.g., program code) that are configured to be executed by one or more processors of a computing device (e.g., an appliance design system). The method 400 can be combined with any of the other methods described herein. For example, the method 400 can be performed as part of the workflow 300 of FIG. 3.

The method 400 can begin at block 402 with receiving at least one image representing a target geometry of an object to be fabricated using an additive manufacturing process. The images can include one or more slices representing a plurality of cross-sections of the object to be fabricated via a layer-by-layer additive manufacturing process, as described herein (e.g., DLPA, SLA, SLS, inkjet). In some embodiments, the images correspond to fabrication instructions for controlling application of energy to a precursor material (e.g., resin or powder) to fabricate the object via the layer-by-layer additive manufacturing process. For example, the pixels within the image can indicate whether energy should be applied to a corresponding location in the precursor material to form a portion of the object, and, optionally, the parameters of the energy to be applied to that location (e.g., intensity, exposure time, dosage, wavelength). The images can be black and white images or grayscale images, and can be provided in any suitable file format (e.g., BMP files, PNG files).

At block 404, the method 400 can include determining a predicted geometry of the object after fabrication using the additive manufacturing process. The predicted geometry can be generated using a prediction algorithm that is configured to receive the at least one image representing the target geometry as input, and to generate a digital representation of the predicted geometry of the object as output. For example, the digital representation can include one or more images of the predicted geometry, a 3D model of the predicted geometry, or suitable combinations thereof.

In some embodiments, the prediction algorithm is or include at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., principle component analysis (PCA), independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof.

A machine learning algorithm can be trained to predict object geometries after manufacturing. For instance, the machine learning algorithm can be trained to predict the object geometry after the object is fabricated via the additive manufacturing process (e.g., SLA, DLP, SLS), based on instructions generated from the at least one image representing the target object geometry. Optionally, the machine learning algorithm can also be trained to predict the object geometry after the fabricated object has undergone one or more post-processing operations, such as material removal (e.g., centrifuging), post-curing, washing, etc. In some embodiments, the machine learning algorithm is trained to predict deviations from the target geometry of the object due to overcuring of a material used to fabricate the object, overbuild of a material used to fabricate the object, retention of a material on a surface of the object, loss of material from the object, deformation of the object, or a combination thereof.

The training data for the machine learning algorithm can include data of other objects that were fabricated using the same additive manufacturing process and/or have undergone the same post-processing operations. For instance, in embodiments where the object is a dental appliance, the training data can include data of other dental appliances, which may include dental appliances of the same type as the dental appliance, dental appliances of a different type than the dental appliance, or suitable combinations thereof. Alternatively or in combination, the training data for the machine learning algorithm can include data of reference objects that were fabricated using the same additive manufacturing process and/or have undergone the same post-processing operations. The reference objects can be coupons having a standardized shape and geometry (e.g., blocks, bars, cylinders, etc., having a known size and shape).

The training data can include data for any suitable number of objects, such as at least 5, 10, 20, 50, 100, 500, or 1000 objects; and/or no more 1000, 500, 100, 50, 20, 10, or 5 objects. For each object, the training data can include a first digital representation of the target geometry of the object (e.g., a first set of images representing the target geometry), and a second digital representation of the actual geometry of the object after additive manufacturing and/or post-processing (e.g., a second set of images representing the actual geometry). Training can be performed using any suitable approach, such as supervised learning, unsupervised learning, or reinforcement learning.

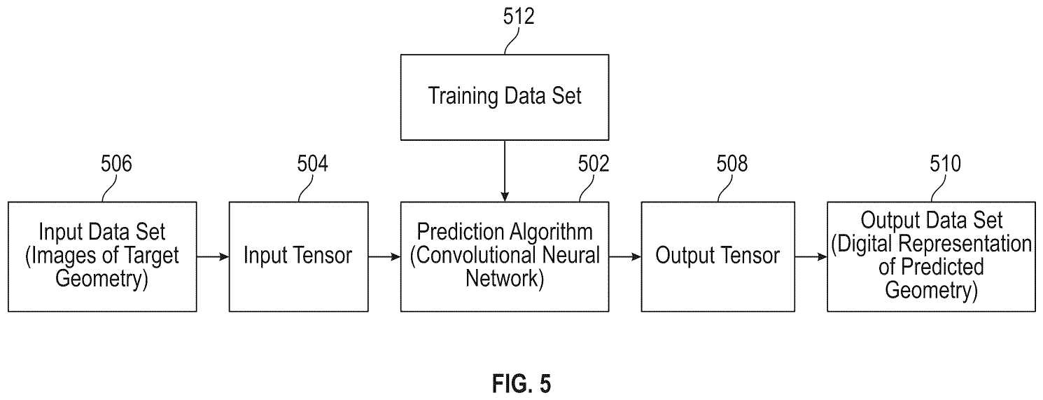

FIG. 5 is a block diagram illustrating a representative example of a prediction algorithm 502 for predicting manufacturing outcomes, in accordance with embodiments of the present technology. The prediction algorithm 502 can be used in the process of block 404 to determine a predicted geometry of an object after additive manufacturing and/or post-processing. In the embodiment of FIG. 5, the prediction algorithm 502 is or includes a convolutional neural network (CNN) that is trained to perform the prediction. CNNs are a type of machine learning algorithm that can be used in the processing of images and/or other array-like data structures. A CNN is composed of a plurality of layers, with each layer including one or more neurons to which the operations described herein are applied. The CNN can transform input data (e.g., data received at an input layer) into output data (e.g., data output by an output layer) through a network architecture including a plurality of intermediate layers. In some embodiments, the plurality of intermediate layers include one or more convolutional layers. Each convolutional layer of a CNN can apply at least one filter (also known as a “kernel”) to input data from a preceding layer via a convolutional operation. In some embodiments, the kernel includes one or more functions, as discussed further herein. The parameters of the kernel (e.g., kernel size, weight, biases, parameters of the kernel function(s)) can be learned from training data (e.g., using backpropagation). The CNN can optionally include multiple convolutional layers, with the input data for each convolutional layer including output data from a preceding layer (e.g., another convolutional layer or another type of layer). In some embodiments, the CNN includes one or more additional layers besides the one or more convolutional layers, such as at least one pooling layer and/or at least one fully connected layer. Further, the CNN can include any arrangement of layers forming a customized network architecture. The prediction produced by the CNN can include output data determined from a convolutional layer or any other layer of the CNN.

In some embodiments, the CNN includes a kernel that is designed based on physical and/or chemical phenomena associated with the additive manufacturing process and/or a post-processing operation. Specifically, the kernel can include at least one function that represents a physical and/or chemical phenomenon associated with the additive manufacturing process and/or post-processing operation. For example, in embodiments where the additive manufacturing process involves application of light energy to cure a precursor material (e.g., a photopolymerization process such as SLA, DLP, inkjet, etc.), the kernel can include one or more functions representing one or more of the following phenomena: light absorption by the precursor material (e.g., Beer-Lambert Law), light scattering within the precursor material (e.g., scattering modeled by a Gaussian distribution), curing kinetics, diffusion, and/or surface tension. As another example, in embodiments where the additive manufacturing process involves application of energy to fuse a precursor material (e.g., a powder bed fusion process such as SLS), the kernel can include one or more functions representing one or more of the following phenomena: thermal conductivity of the powder material, heat transfer and/or distribution within the powder bed (e.g., modeled by Fourier's law), phase transitions of the powder material (e.g., melting and/or solidification dynamics), laser-material interactions (e.g., absorption and/or reflection properties of the powder material), particle size distribution, particle packing density effects, residual stress formation and/or relaxation, and/or the size and intensity distribution of the laser spots (e.g., modeled by a Gaussian distribution or other suitable spatial distributions to reflect the laser's focus and energy dispersion characteristics). The functions can take any suitable form (e.g., depending on the type of physical and/or chemical phenomenon being modeled), such as Gaussian functions, exponential functions, polynomial functions, etc. In embodiments where the kernel includes multiple functions, the functions can be combined via operations such as summing, multiplication, etc. The parameters of the functions can be determined through training of the CNN, as described in detail below. In some embodiments, the use of a kernel designed based on physical and/or chemical phenomena reduces the amount of the training data needed for the CNN to produce an accurate prediction, as discussed below.

For example, in embodiments where the additive manufacturing system involves forming the object by applying light energy to a curable material (e.g., a resin), the kernel can include a composite equation representing the light intensity at each pixel within the curable material. Specifically, a composite equation representing the sum of three modified Gaussian beams may be used to represent the light intensity at each pixel in the x-y plane:

$${I}_{1} ( x , y ) = 0.94 {I}_{0} exp ( - {[ {( \frac{x - {x}_{0}}{2 ( 1.7 {σ}_{x} )} )}^{1.4} + {( \frac{y - {y}_{0}}{2 ( 1.7 {σ}_{y} )} )}^{1.4} ]}^{1.8} ) \qquad ( 1 )$$

$${I}_{2} ( x , y ) = 0.15 {I}_{0} exp ( - {[ {( \frac{x - {x}_{0}}{2 ( 4.5 {σ}_{x}} )}^{1.8} + {( \frac{y - {y}_{0}}{2 ( 4.5 {σ}_{y} )} )}^{1.8} ]}^{1.8} ) \qquad ( 2 )$$

$${I}_{3} ( x , y ) = 0.1 {I}_{0} exp ( - {[ {( \frac{x - {x}_{0 )}}{2 ( 0.45 {σ}_{x} )} )}^{1.4} + {( \frac{y - {y}_{0}}{2 ( 0.45 {σ}_{y} )} )}^{1.4} ]}^{1.8} ) \qquad ( 3 )$$

$$I ( x , y ) = min \{ 0.87 {I}_{0} , min [ 0.78 {I}_{0} , {I}_{1} ( x , y ) + {I}_{2} ( x , y ) ] + {I}_{3} ( x , y ) \} \qquad ( 4 )$$

where σₓ and σ_{y} represent the beam widths in the x- and y-directions, respectively; x₀ and y₀ are coordinates of the pixel center; and I₀ represents the peak intensity.

The kernel may use the Beer-Lambert Law equation to represent the light intensity in the z-direction:

$$I ( z ) = {I}_{0} {e}^{- μ z} \qquad ( 5 )$$

where I₀ represents the intensity at the surface of the curable material and μ is a penetration constant.

The various parameters of the functions in Equations (1)-(5), including but not limited to σₓ and σ_{y} (which define the light range in the x- and y-directions), u (which defines the light decay in the z-direction), and/or the kernel size (x, y, z), can be determined through training, as described further below.

The prediction algorithm 502 can be configured to receive an input tensor 504 (e.g., a 3D tensor) that is generated from an input data set 506 including one or more images representing a target geometry for the object. For example, the images can be a plurality of slices corresponding to a plurality of cross-sections of the object, with the pixels in each image corresponding to voxels in the respective object cross-section. The pixel value can indicate whether the corresponding voxel is intended to be solidified (e.g., cured, sintered) in the target object geometry and, optionally, the degree of solidification desired (e.g., degree of curing). The images can be converted into the input tensor 504 by transforming each image into a grid of numerical values representing the image pixels, then layering or stacking the grids to create a multi-dimensional structure (the 3D tensor). Other image pre-processing that can be performed include cropping the images (e.g., to remove portions that are irrelevant or less relevant to the prediction, such as portions corresponding to empty space), adjusting the size of the images (e.g., to a predetermined image length and image width), adjusting the color of the images (e.g., converting to black and white or grayscale), and suitable combinations thereof.

Based on the input tensor 504, the prediction algorithm 502 can generate an output tensor 508 representing the manufacturing outcome (e.g., predicted geometry) of the object after additive manufacturing and/or post-processing. The output tensor 508 can be the direct output of the convolution performed by the prediction algorithm 502 and can represent the comprehensive prediction data generated by the prediction algorithm 502. For example, the output tensor 508 can represent the predicted solidification of the precursor material after additive manufacturing and/or post-processing, as described herein, and/or it can indicate the predicted cumulative light exposure received at each voxel location. Optionally, the prediction algorithm 502 can include the effects of islands (e.g., parts of the object that are not connected to any other parts of the object or are otherwise unsupported) being reduced or eliminated as part of the computation graph, such that the object geometry represented by the output tensor 508 includes few or no islands.

In some embodiments, the output tensor 508 is generated by performing a convolution (e.g., a 3D convolution) on the input tensor, using the trained CNN. For example, the output tensor can be generated using the following convolution equation:

$$out = {\sum }_{k} kernel ( - k ) * input ( k ) \qquad ( 6 )$$

where input is the input tensor 504, out is the output tensor 508, kernel is the kernel of the CNN, and k represents the position index in the tensor. To increase computing efficiency, the convolution can be performed using a computing system or device including a graphics processing unit (GPU), a tensor processing unit (TPU), or suitable combinations thereof.

In some embodiments, the output tensor 508 is subsequently converted into an output data set 510 that provides a digital representation of the predicted geometry of the object. The output data set 510 can be in any suitable file format, e.g., for enhanced visualization and/or potential subsequent processing. For example, the output data set 510 can include a plurality of predicted images corresponding to a plurality of predicted cross-sections of the object, with the pixels in each image representing a prediction of the corresponding voxel in the respective object cross-section. The pixel value can indicate whether the corresponding voxel is solidified in the predicted object geometry, and, optionally, the predicted degree of solidification. The pixel value can be a binary value (e.g., black or white) or can be a grayscale value. Alternatively or in combination, the output data set 510 can be in a VTK (Visualization Toolkit) XML Image Data (VTI) format, which may be useful for detailed 3D visualization and can allow for a more nuanced examination of the predicted object geometry. Optionally, the output data set 510 can include a 3D digital model (e.g., in a 3D file format such as STL format). The flexibility in the format of the output data set 510 not only broadens the applicability of the prediction algorithm 502, but also facilitates seamless integration into various stages of the manufacturing and post-processing workflow.

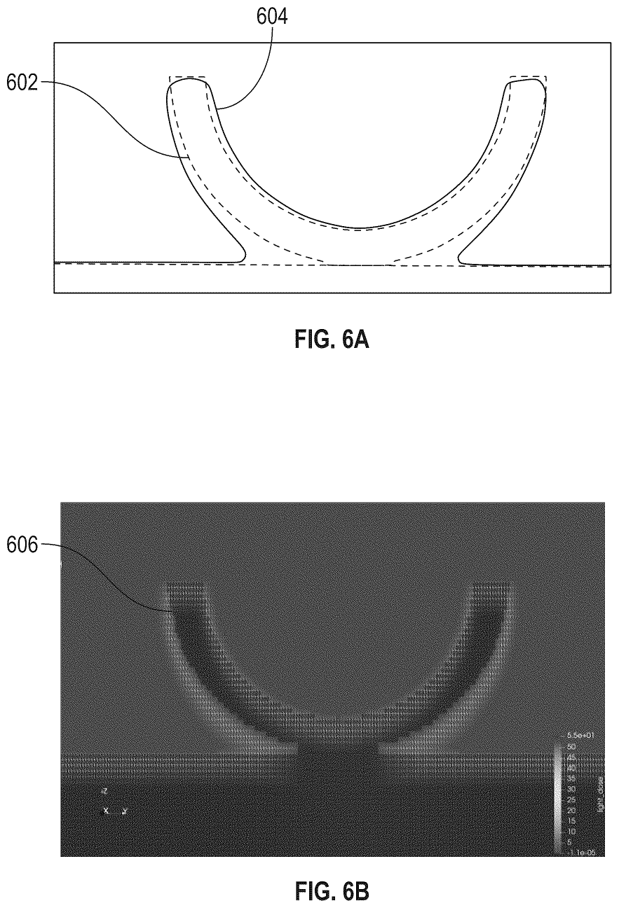

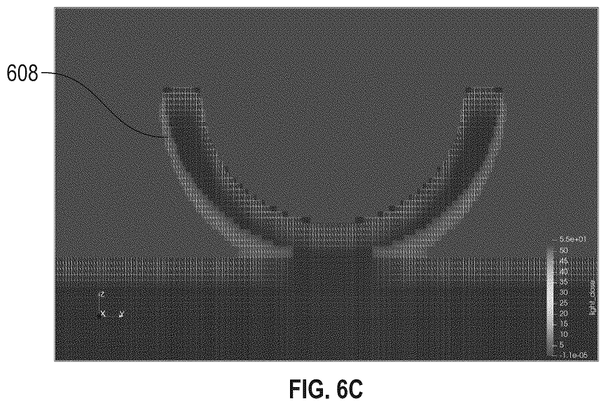

In some embodiments, the output tensor 508 produced by the prediction algorithm 502 and/or the output data set 510 undergo post-processing before subsequent use (e.g., in an optimization routine, as described elsewhere herein). For instance, in embodiments where the output tensor 508 includes a plurality of scalar values representing the accumulated light dose derived from convolution results, a threshold can be applied to the output tensor 508 to filter the results. The threshold value can be determined based on experimental data. For example, FIGS. 6A-6C illustrate determination of an experimentally calibrated threshold for filtering prediction results, in accordance with embodiments of the present technology. FIG. 6A is a cross-sectional view of a target geometry 602 for an object (e.g., a calibration coupon) together with an actual geometry 604 of the object after fabrication. For instance, the target geometry 602 can correspond to a CAD design file for the object (e.g., an STL file) and the actual geometry 604 can correspond to scan data of the fabricated object. As shown in FIG. 6A, the actual geometry 604 may deviate from the target geometry 602. FIG. 6B is an image representing a cross-sectional view of a predicted geometry 606 for the object. The predicted geometry 606 can be generated from the target geometry 602 using a prediction algorithm (e.g., the prediction algorithm 502 of FIG. 5), as described herein. The predicted geometry 606 can be compared to the actual geometry 604 of the fabricated object to determine a threshold value that, when applied to the image, causes the predicted geometry 606 to match the actual geometry 604 (e.g., by filtering out pixels in the predicted geometry 606 that deviate from the pixels in the actual geometry 604). FIG. 6C is an image representing a cross-sectional view of a predicted geometry 608 after the threshold value has been applied.

Referring again to FIG. 5, the prediction algorithm 502 can be trained to generate predictions of manufacturing outcomes using a training data set 512. The training data set 512 can include image data of other objects that were previously fabricated, e.g., using the same or similar additive manufacturing process and/or the same or similar post-processing operations. For instance, in embodiments where the object to be fabricated is a dental appliance, the training data set 512 can include data of previously fabricated dental appliances, which may be dental appliances of the same type as the dental appliance to fabricated, dental appliances of a different type than the dental appliance to be fabricated, or suitable combinations thereof. Alternatively or in combination, the training data set 512 can include image data of reference objects that were previously fabricated, e.g., using the same or similar additive manufacturing process and/or the same or similar post-processing operations. The reference objects can be coupons having a standardized shape and geometry (e.g., blocks, bars, cylinders, etc., having a known size and shape). In some embodiments, because the prediction algorithm 502 is designed based on physical and/or chemical phenomena involved in the additive manufacturing process and/or post-processing operations, the training data set 512 can be relatively small compared to conventional data sets for training CNNs. For example, the training data set 512 can include image data for no more than 50, 25, 20, 15, 10, or 5 objects. Alternatively, larger amounts of training data can be used, e.g., the training data set 512 can include image data for at least 50, 100, 200, 500, or 1000 objects.

In some embodiments, the training data set 512 includes, for each object, one or more first images representing a target geometry of the object, and one or more second images representing an actual geometry of the object after additive manufacturing and/or post-processing. The one or more first images can be slices representing cross-sections of the object used to produce instructions for fabricating the object in a layer-by-layer additive manufacturing process (e.g., slices generated from a CAD file of the object). The one or more second images can be photographs, scan data (e.g., microCT data), and/or other data providing a digital representation of the actual cross-sectional geometry of the object after fabrication. In some embodiments, the training process involves providing the first images to the prediction algorithm 502 as the input data set 506, generating an output data set 510 including one or more predicted images using the prediction algorithm 502, then comparing the predicted images to the second images to determine whether the predicted geometry matches the actual geometry. The comparison can be used to calculate an error between the predicted and actual geometry, e.g., using a loss function such as mean squared error (MSE), mean absolute error (MAE), binary cross-entropy loss, categorical cross-entropy loss, dice loss, structural similarity index (SSIM), Huber loss, L1 loss, L2 loss, etc., or suitable combinations thereof. The error can be used to update the parameters of the prediction algorithm 502. For example, the parameters of the CNN (e.g., corresponding to the parameters of the kernel function(s) of the CNN) can be updated based on the calculated error using backpropagation. The training can be performed until the prediction algorithm 502 achieves sufficient accuracy. Optionally, a portion of the training data set 512 can be reserved to validate the accuracy of the trained prediction algorithm 502.

The prediction algorithm 502 can be customized to a particular additive manufacturing process and/or post-processing operation, depending on the training data set 512 used. For instance, the prediction algorithm 502 can be trained to consider some or all of the following conditions and/or parameters associated with additive manufacturing and/or post-processing: the type of additive manufacturing process (e.g., DLP, SLA, SLS), printing parameters of the additive manufacturing system (e.g., curing time, grayscale level, printing speed, light intensity, minimum feature size, minimum layer height, print resolution, print unit shape, print directionality, print offset, an expected amount of overcuring and/or overbuild), properties of the precursor material used to fabricate the object (e.g., viscosity, optical properties, light transmittance, light scattering), and/or post-processing conditions (e.g., conditions due to centrifuging, washing, post-curing, etc., such as temperature, applied forces, exposure to solvents and/or other chemicals, etc.). In such embodiments, the training data set 512 can include data of one or more objects that were fabricated using the particular conditions and/or parameters to be considered by the prediction algorithm 502.

In some embodiments, the prediction algorithm 502 uses a divide and conquer approach to determine the predicted object geometry. A divide and conquer approach can be beneficial to reduce processing requirements and/or to increase processing speed (e.g., using parallel processing). For example, the object geometry can be divided into a plurality of smaller portions, the prediction algorithm 502 can generate a respective prediction for each smaller portion (e.g., sequentially or in parallel), and the predictions can be combined to produce a single prediction for the entire object geometry. In embodiments where the prediction algorithm 502 is or includes a CNN, the divide and conquer approach can involve generating a plurality of input tensors (e.g., based on images of a plurality of smaller portions of the object), performing convolutions on the plurality of input tensors using the CNN to generate a plurality of respective output tensors, then combining the output tensors to produce a single output tensor representing the predicted geometry for the entire object. The object can be divided into smaller portions in any suitable manner, e.g., the object can be divided into smaller portions of the same size or of different sizes, with the size of each portion being determined based on the type of object, relative importance of that portion, expected amount of deviation at that portion, geometric complexity of that portion, processing constraints, and/or other relevant considerations. In some embodiments, predictions may not need to be made for certain portions of the object, e.g., if those portions are not important for the function of the object, if those portions correspond to empty space in or around the object, if no significant deviations are expected at those portions, etc. In other embodiments, however, the prediction algorithm 502 can generate a prediction for the entire object geometry at once, rather than using a divide and conquer approach.

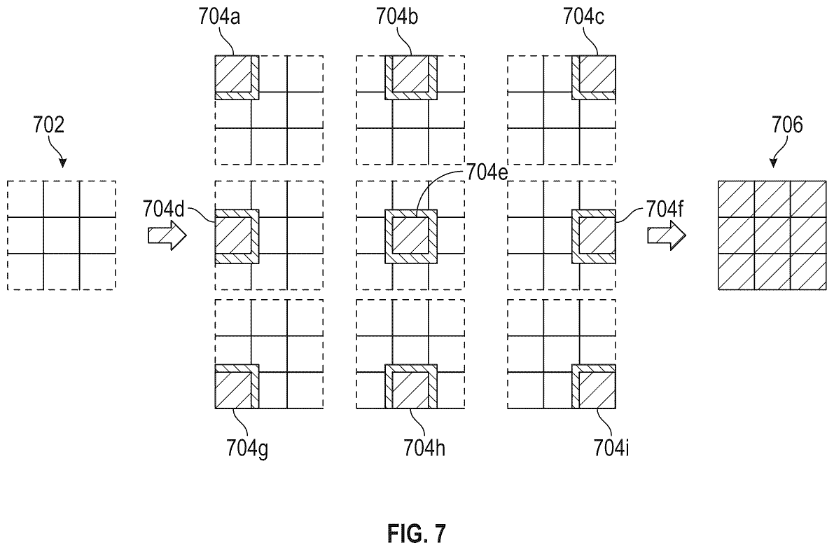

FIG. 7 is a schematic illustration of a divide and conquer approach that may be used by the prediction algorithm 502, in accordance with embodiments of the present technology. The divide and conquer approach can be applied to an input tensor 702 (e.g., representing a target geometry for the object). The input tensor 702 can be divided into a plurality of smaller portions 704a-704i, some or all of which can include overlapping regions. In the illustrated embodiment, for example, portion 704a includes regions that overlap with neighboring portions 704b, 704c, and 704d; portion 704b includes regions that overlap with neighboring portions 704a, 704c, 704d, 704c, and 704f; etc. The smaller portions 704a-704i can be individually input into the prediction algorithm to generate a respective prediction for each portion. Subsequently, the overlapping regions can be removed from the predictions for each smaller portion 704a-704i, and the “cropped” predictions can be combined with each other to generate a single output tensor 706 (e.g., representing the predicted geometry for the object). The use of a divide and conquer approach with overlapping regions in the divided portions can provide various advantages, such as mitigating potential issues related to the kernel size and/or edge effects that may occur in CNN processing, thus leading to a more accurate and consistent prediction. This approach can be used to replicate the results that would be achieved using a CNN on the entire object in a single instance, thereby maintaining the integrity and precision of the prediction across the entire geometry of the object.

Referring again to FIG. 5, although this embodiment has been described with respect to a CNN-based prediction algorithm 502, in other embodiments, the prediction algorithm 502 can alternatively or additionally be modified to utilize other types of machine learning algorithms, such as recurrent neural networks (RNNs), generative adversarial networks (GANs), capsule networks (CapsNets), graph neural networks (GNNs), autoencoders, vision transformers (ViTs), other types of artificial neural networks (ANNs), or any of the other machine learning algorithm types described herein.

Referring again to FIG. 4, at block 406, the method 400 can include identifying a deviation between the target geometry and the predicted geometry. The deviation can be identified by comparing the initial images of the target geometry received at block 402 to the predicted images generated in block 404 (e.g., by the prediction algorithm 502 of FIG. 5). Specifically, each initial image can be compared to a corresponding predicted image to determine locations where the object geometry shown in the initial image differs from the object geometry shown in the predicted image and, optionally, the size (e.g., distance) of the discrepancy. In some embodiments, the deviation is computed using a loss function, such as mean squared error (MSE), mean absolute error (MAE), binary cross-entropy loss, categorical cross-entropy loss, dice loss, structural similarity index (SSIM), Huber loss, L1 loss, L2 loss, etc., or suitable combinations thereof.

At block 408, the method 400 can continue with modifying the at least one image based on the identified deviation. In some embodiments, the modification is made only if the deviations are significant (e.g., exceed a predetermined threshold and/or occur at an important portion of the object), while in other embodiments, the modification is made if any deviations are detected, regardless of their significance. The acceptable amount of deviation may be uniform across the entire object, or the acceptable amount of deviation may differ for different portions of the object (e.g., larger deviations may be acceptable for portions of the object that are less important for the proper function of the object).

The modification can be made to some or all of the initial images received at block 402 in order to reduce or otherwise mitigate the deviations between the target geometry and the predicted geometry. For instance, the modification can change the size, shape, location, and/or grayscale values of some or all of the object cross-sections represented in the initial images, such that an object fabricated based on the modified images more closely resembles the target geometry than an object manufactured based on the initial images. In some embodiments, the modification is made are made on a pixel or voxel level, such that each pixel or voxel in any of the images (and/or the corresponding tensor) can be changed individually.

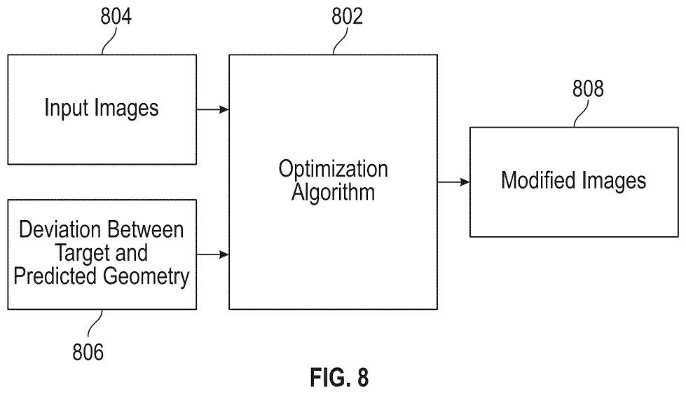

FIG. 8 is a block diagram illustrating a representative example of an optimization algorithm 802 for generating modified images, in accordance with embodiments of the present technology. The optimization algorithm 802 can be used in the process of block 408 to determine one or more modified images to reduce or mitigate deviations between a target geometry and a predicted geometry for an object. As shown in FIG. 8, the inputs to the optimization algorithm 802 include one or more input images 804 (e.g., the initial images of the target geometry for the object). The inputs can also include the identified deviation 806 (e.g., output of the loss function) between the target geometry for the object and the predicted geometry of the object when fabricated according to the geometry specified by the input images 804. The output of the optimization algorithm 802 is one or more modified images 808 that are configured to produce an object having a geometry that is more similar to the target geometry than the predicted geometry resulting from the input images 804. In some embodiments, the input images 804 and deviation 806 are provided to the optimization algorithm 802 as respective input tensors, and the modified images 808 generated by the optimization algorithm 802 are provided as an output tensor.

The optimization algorithm 802 can implement an optimization process to adjust the size, shape, location, grayscale values, etc., of the object geometry depicted in some or all of the input images 804 to produce the modified images 808. As noted above, the adjustments can be made to the individual pixels or voxels in the input images 804. The optimization process can include one or more optimization functions, such as stochastic gradient descent (SGD), Adam (Adaptive Moment Estimation), RMSprop (Root Mean Square Propagation), Adagrad (Adaptive Gradient Algorithm), Adadelta, Nadam (Nesterov-accelerated Adaptive Moment Estimation), etc. Optionally, the learning rate of the optimization function may be selected to avoid instability and/or overshooting while maintaining sufficiently fast processing times. The learning rate may determine the size of the steps that the optimization function takes toward the minimum of the loss function. The appropriate learning rate may vary, e.g., depending on the location of the deviation, type of object, type of additive manufacturing process and/or post-processing operation, etc. In some embodiments, the learning rate has a value of about 0.001×, 0.0002×, 0.003×, 0.005×, 0.0075×, 0.01×, 0.02×, 0.03×, 0.05×, 0.075×, 0.1×, 0.2×, 0.3×, 0.4×, or 0.5×.

In some embodiments, the optimization algorithm 802 is an inverse optimization algorithm. The inverse optimization algorithm can modify the input images 804 by inverting the deviations 806 (e.g., changing positive distances to negative distances, and vice-versa), then applying the inverted deviations to the input images 804 to generate the modified images 808.

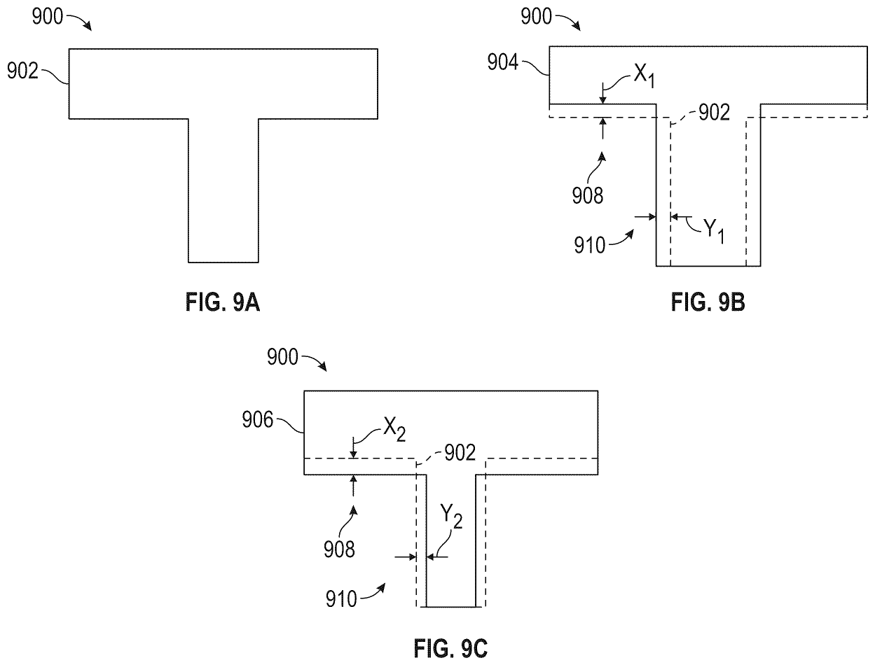

For example, FIGS. 9A-9C schematically illustrate a representative example of an inverse optimization process for modifying a geometry of an object 900, in accordance with embodiments of the present technology. Specifically, FIG. 9A illustrates a target geometry 902 for the object 900, FIG. 9B illustrates a predicted geometry 904 of the object 900, and FIG. 9C illustrates a modified geometry 906 for fabricating the object 900 that may be generated via an inverse optimization algorithm (e.g., the optimization algorithm 802 of FIG. 8). As shown in FIGS. 9A and 9B, the predicted geometry 904 of the object 900 deviates from the target geometry 902 (depicted in broken lines in FIG. 9B) by a distance X₁ at a first portion 908 of the object 900, and by a distance Y₁ at a second portion 910 of the object 900. The distance X₁ can be a negative value (indicating that the predicted geometry 904 is smaller than the target geometry 902 at the first portion 908), and the distance Y₁ can be a positive value (indicating that the predicted geometry 904 is larger than the target geometry 902 at the second portion 910).

Referring next to FIG. 9C, the inverse optimization algorithm can generate a modified geometry 906 for the object 900 by inverting the identified deviations at the first portion 908 and the second portion 910. For instance, the modified geometry 906 can be produced by applying a positive distance X₂ to the first portion 908 of the object 900 (resulting in the modified geometry 906 being larger than the target geometry 902 at the first portion 908), and by applying a negative distance Y₂ to the second portion 10 of the object 900 (resulting in the modified geometry 906 being smaller than the target geometry 902 at the second portion 910). The distance X₂ can have the same magnitude as the distance X₁, or can have a magnitude that is a multiple of the magnitude of the distance x₁ (e.g., 0.25×, 0.5×, 0.75×, 1×, 1.25×, 1.5×, 1.75×, or 2×). Similarly, the distance Y₂ can have the same magnitude as the distance y₁, or can have a magnitude that is a multiple of the magnitude of the distance Y₁ (e.g., 0.25×, 0.5×, 0.75×, 1×, 1.25×, 1.5×, 1.75×, or 2.×).

Referring again to FIG. 8, the modifications made by the optimization algorithm 802 to the input images 804 may be subject to one or more constraints. For instance, the constraints can limit the magnitude of the changes made to the object geometry, e.g., to ensure that the optimization algorithm 802 can converge to a stable result. Other constraints that may be applied include constraining the minimum feature size in the modified geometry to be greater than the minimum feature size of the additive manufacturing system, avoiding feature shapes that may not be manufacturable (e.g., island, overhangs), limiting the types of changes made at important portions of the object (e.g., to avoid interfering with the function of the object), and/or suitable combinations thereof. For instance, the optimization algorithm can penalize outputs that generate islands.

In some embodiments, the optimization algorithm 802 uses a divide and conquer approach to determine the modified object geometry, which may be beneficial to reduce processing requirements and/or to increase processing speed (e.g., using parallel processing), as discussed herein. For example, the object geometry can be divided into a plurality of smaller portions, the optimization algorithm 802 can determine a respective modification for each smaller portion (e.g., sequentially or in parallel), and the modified portions can be combined to the modified geometry for the entire object. The object can be divided into smaller portions in any suitable manner, e.g., the object can be divided into smaller portions of the same size or of different sizes, with the size of each portion being determined based on the type of object, relative importance of that portion, amount of deviation at that portion, geometry complexity of that portion, processing constraints, and/or other relevant considerations. Optionally, the smaller portions may include overlapping regions, e.g., as described above in connection with FIG. 7. In some embodiments, certain portions of the object may not need to be modified by the optimization algorithm 802, e.g., if those portions are not important for the function of the object, if those portions correspond to empty space in or around the object, if no significant deviations were observed at those portions, etc. In other embodiments, however, the optimization algorithm 802 can generate a modified geometry for the entire object at once, rather than using a divide and conquer approach.

The modified images 808 produced by the optimization algorithm 802 can represent an object geometry that, when used as a basis for fabricating the object, is expected to produce improved manufacturing accuracy, such that the actual geometry of the resulting object is expected to be identical or sufficiently similar to the target geometry (e.g., there are no significant deviations between the actual geometry and the target geometry, and/or any deviations that are present do not occur at important portions of the object). In some embodiments, the modified object geometry represented in the modified images 808 differs from the target geometry represented in the input images 804, but an object fabricated based on the modified images 808 is expected to have a geometry closer to the target geometry than an object fabricated based on the input images 804.

Referring again to FIG. 4, the method 400 can subsequently return to block 404 to determine a predicted geometry of the object, based on the modified images produced in block 408. The prediction process can be the same as described above, except that the one or more modified images representing the modified object geometry are used as the input for the prediction algorithm. The method 400 can then proceed to block 406 with identifying any deviations between the target geometry and the predicted geometry based on the modified images, as previously described. If the deviations are significant, the method 400 can continue to block 408 to make further modifications to the modified images to reduce or mitigate the deviations. The modification process can be the same as described above, except that the input images to the optimization algorithm are the modified images rather than the initial images of the target geometry. In some embodiments, the processes of block 404, 406, and 408 are repeated to iteratively modify the images until the predicted manufacturing accuracy is satisfactory (e.g., the predicted deviations are sufficiently small and/or do not occur at important portions of the object).

At block 410, the method 400 can include generating instructions for fabricating the object using the additive manufacturing process, based on the modified images produced in block 408. The instructions can be configured to control an additive manufacturing system (e.g., an SLA, DLP, SLS, inkjet, or a hybrid printing system) to apply energy to solidify a precursor material according to the object geometry represented in the modified images. For instance, the modified images can represent locations to which energy is to be applied (and, optionally parameters for the energy application) in order to sequentially form a plurality of object cross-sections according to a layer-by-layer additive manufacturing process, as described elsewhere herein.

In some embodiments, the process of block 410 involves converting the modified images into a format suitable for controlling the additive manufacturing system (e.g., a G-code file). Optionally, some or all of the modified images can undergo image post-processing before and/or during the conversion process. For instance, the image post-processing can include removing artifacts from the modified images (e.g., islands, spikes, holes, and/or other discontinuities), adjusting the size of the modified images (e.g., to a predetermined image length and image width), adjusting the color of the modified images (e.g., converting to black and white or grayscale), adjusting the modified images to improve printability (e.g., ensuring that the minimum feature thickness is greater than the minimum thickness for printability, increasing the thickness of the bottom layer of the object), or suitable combinations thereof. The image post-processing can also include adding components to the object geometry, such as support structures to stabilize the object during additive manufacturing and/or post-processing (e.g., struts, blocks, crossbars, etc.), identifiers for tracking the object (e.g., tags, labels, barcodes, QR codes, etc.), and so on.

The method 400 illustrated in FIG. 4 can be modified in many different ways. For example, although the above steps of the method 400 are described with respect to a single object, the method 400 can be used to sequentially or concurrently generate instructions for fabricating any suitable number of objects, such as tens, hundreds, or thousands of objects. As another example, the ordering of the processes shown in FIG. 4 can be varied. Some of the processes of the method 400 can be omitted, and/or the method 400 can include additional processes not shown in FIG. 4. For instance, the method 400 can additionally include displaying a graphical representation of the predicted geometry, identified deviations, and/or modified images to a user (e.g., a technician or a clinician), via a suitable display device (e.g., a monitor, screen, etc., of a computing system or device). In such embodiments, the user can provide feedback to approve the modified images or make adjustments to the modified images, if appropriate.

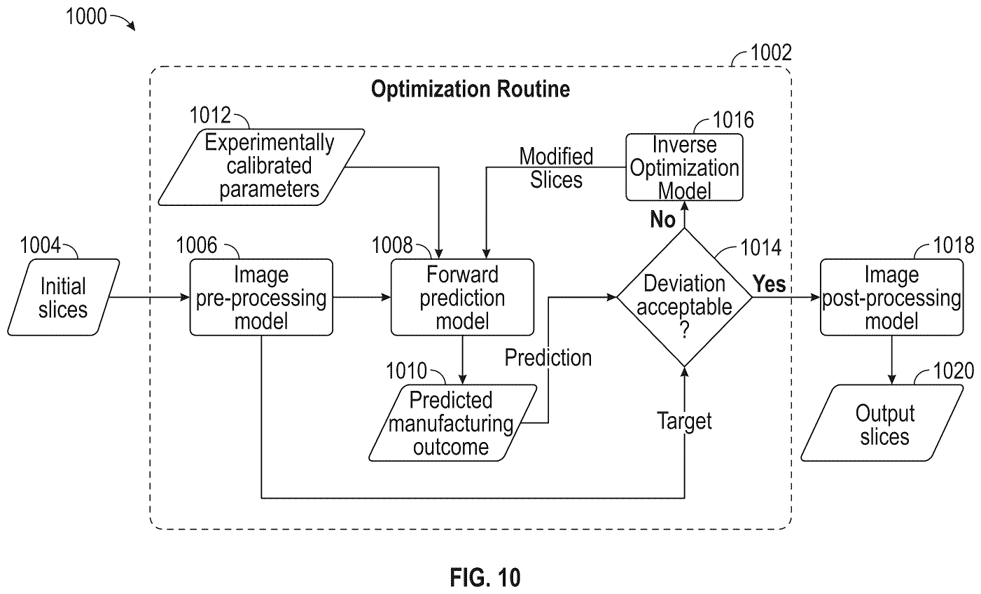

FIG. 10 is a block diagram illustrating a workflow 1000 for generating instructions for additive manufacturing of an object, in accordance with embodiments of the present technology. The workflow 1000 can be implemented in combination with any of the other processes described herein (e.g., in connection with the workflow 300 of FIG. 3 and/or the method 400 of FIG. 4).

The workflow 1000 includes an optimization routine 1002 for determining (e.g., optimizing) a set of slices for manufacturing an object (e.g., a dental appliance). As shown in FIG. 10, a plurality of initial slices 1004 are provided to an image pre-processing model 1006. The initial slices 1004 can be a plurality of images (e.g., black and white images, grayscale images) representing a target geometry of the object. The slices can correspond to a plurality of cross-sections (e.g., layers) of the object for fabrication via a layer-by-layer additive manufacturing process (e.g., SLA, DLP, SLS, inkjet). In some embodiments, the slices are generated from a 3D digital model (e.g., a CAD model) of the object via a slicing process, as described else where herein.

The initial slices 1004 can be provided to an image pre-processing model 1006 that includes one or more software algorithms configured to perform image pre-processing of the slices 1004. The image pre-processing can include any of the operations disclosed herein, such as cropping the slices, adjusting the sizes of the slices, adjusting the color of the slices, converting the slices into a 3D tensor, and/or suitable combinations thereof.

The output of the image pre-processing model 1006 can be provided to a forward prediction model 1008. The forward prediction model 1008 includes one or more software algorithms configured to generate a predicted manufacturing outcome 1010, based on the initial slices. For example, the predicted manufacturing outcome 1010 can be a prediction of the object geometry after additive manufacturing based on the initial slices and/or post-processing. The forward prediction model 1008 can include any of the prediction algorithms described herein (e.g., in connection with block 404 of FIG. 4 and/or FIG. 5), such as a machine learning algorithm. In some embodiments, the forward prediction model 1008 is or includes a CNN that is configured to apply a convolution operation (e.g., Equation 6) to the input slices to generate a plurality of predicted slices representing the predicted object geometry.

The forward prediction model 1008 can include one or more experimentally calibrated parameters 1012 that are determined from experimental data, e.g., data of other objects fabricated using the same or similar additive manufacturing process and/or post-processing operations. For example, the experimental data can be used to determine the parameters of the CNN kernel (e.g., kernel size in x, y, and/or z; form of the kernel function(s); parameters of the kernel function(s) (e.g., σₓ, σ_{y}, and/or μ in Equations (1) (5)). As another example, the experimental data can be used to determine a threshold to be applied to the convolution result, e.g., to remove artifacts, avoid printability issues, etc. In some embodiments, some or all of the experimentally calibrated parameters 1012 are determined through training of the CNN (or other machine learning algorithm implemented by the forward prediction model 1008), as described elsewhere herein.

The prediction of the object geometry (represented in the predicted manufacturing outcome 1010) can be compared to the target object geometry (represented in the pre-processed slices) to identify whether any deviations are present and, if so, whether the deviations are acceptable (block 1014). The deviations can be considered to be unacceptable, for instance, if they exceed a predetermined threshold (e.g., manufacturing tolerances) and/or if they occur at portions of the object that are important to the properties and/or function of the object (e.g., portions of a dental appliance that apply forces to teeth). In some embodiments, the deviation is determined using a loss function.

If the deviations are unacceptable, the workflow 1000 can use an inverse optimization model 1016 to generate modified slices to reduce, prevent, or otherwise mitigate the deviations. The inverse optimization model 1016 includes one or more software algorithms configured to adjust the size, shape, location, grayscale values, etc., of the object geometry depicted in the initial slices to produce the modified slices as described herein (e.g., in connection with block 406 of FIG. 4, FIG. 8, and/or FIGS. 9A-9C). The modified slices can then be provided to the forward prediction model 1008 to generate an updated predicted manufacturing outcome 1010. The optimization routine 1002 can be repeated to iteratively modify the slices until the deviations between the predicted and target geometry of the object are acceptable, e.g., the deviations are below a predetermined threshold and/or do not occur at important portions of the object.

The modified slices resulting from the optimization routine 1002 can be provided to an image post-processing model 1018 that includes one or more software algorithms configured to perform image post-processing of the modified slices. The image post-processing can include any of the operations disclosed herein, such as removing artifacts (e.g., islands, spikes, holes, and/or other discontinuities), adjusting the size of the slices, adjusting the color of the slices, adjusting the grayscale values of the slices, modifying the slices to improve printability (e.g., via filtering, thresholding, smoothing, increasing the thickness of the bottom layer of the object), and/or suitable combinations thereof.

The output of the image post-processing model 1018 can be a plurality of output slices 1022 that can be used to generate instructions for additive manufacturing of the object. For example, the output slices 1022 can be a plurality of images (e.g., black and white images, grayscale images) indicating how energy should be applied to a precursor material in order to fabricate a plurality of cross-sections of the object via a layer-by-layer additive manufacturing process.

Optionally, the optimization routine 1002 can be periodically recalibrated to reflect changes in the additive manufacturing process and/or post-processing operations, such as changes in system type, material types, process parameters, etc. Recalibration may alternatively or additionally be performed to improve the results produced by the optimization routine 1002 over time, e.g., to ensure that the output slices 1022 produce object geometries that trend toward the middle of the desired range of tolerances. Recalibration may be performed by fabricating one or more reference objects with a known target geometry (e.g., coupons) using the new process, then measuring the actual geometry of the reference objects after fabrication. The target geometry, the actual geometry, and/or the deviations between the target geometry and the actual geometry can be stored in a recalibration data set (e.g., a recalibration file) that can then be used to update the parameters of the optimization routine 1002 (e.g., the parameters of the forward prediction model 1008 and/or inverse optimization model 1016).

The various elements of the workflow 1000 can be implemented using any suitable combination of hardware and software components. For example, some or all of the processes of the workflow 1000 can be implemented using one or more computing systems or devices having one or more processors and memory configured to perform the various operations described herein. The computing systems or devices can include components configured to increase the efficiency of convolutional operations, such as a GPU or a TPU.

Moreover, the configuration of the workflow 1000 illustrated in FIG. 10 can be varied in many ways. For example, any of the components of the workflow 1000 shown as distinct components in FIG. 10 can be combined and/or include interrelated code. Any of the components of the workflow 1000 can be implemented as a single and/or interrelated piece of software, or as different pieces of software. Any of the components of the workflow 1000 can be embodied on a single machine or any combination of multiple machines. Although the workflow 1000 is described above with respect to a single object, the workflow 1000 can be used to sequentially or concurrently generate instructions for fabricating any suitable number of objects, such as tens, hundreds, or thousands of objects. Some of the components of the workflow 1000 can be omitted (e.g., the image pre-processing model 1006 and/or the image post-processing model 1018), and/or the workflow 1000 can include additional components not shown in FIG. 10. Furthermore, any of the processes of the workflow 1000 can optionally be implemented using a divide and conquer approach.

In some embodiments, the present technology provides methods for determining instructions for fabricating an object with an actual geometry that conforms more closely to the target geometry, where the methods can be performed with decreased computational time and/or resources. Algorithms that are computationally intensive to perform may be poorly suited for high volume manufacturing of large numbers of objects with unique geometries. The present technology provides algorithms that may produce an optimized set of object slices and/or fabrication instructions for a single object in a relatively short time period, e.g., no more than 10 minutes, 5 minutes, 2 minutes, 1 minutes, or 30 seconds. The algorithm may be a “surrogate algorithm” that receives images of an object to be fabricated and determines modifications to the images to produce better manufacturing accuracy, without needing to perform an iterative prediction and optimization workflow to arrive at the modified images. Accordingly, faster processing and manufacturing times can be achieved while still ensuring that the final printed object exhibits high fidelity to the intended design.

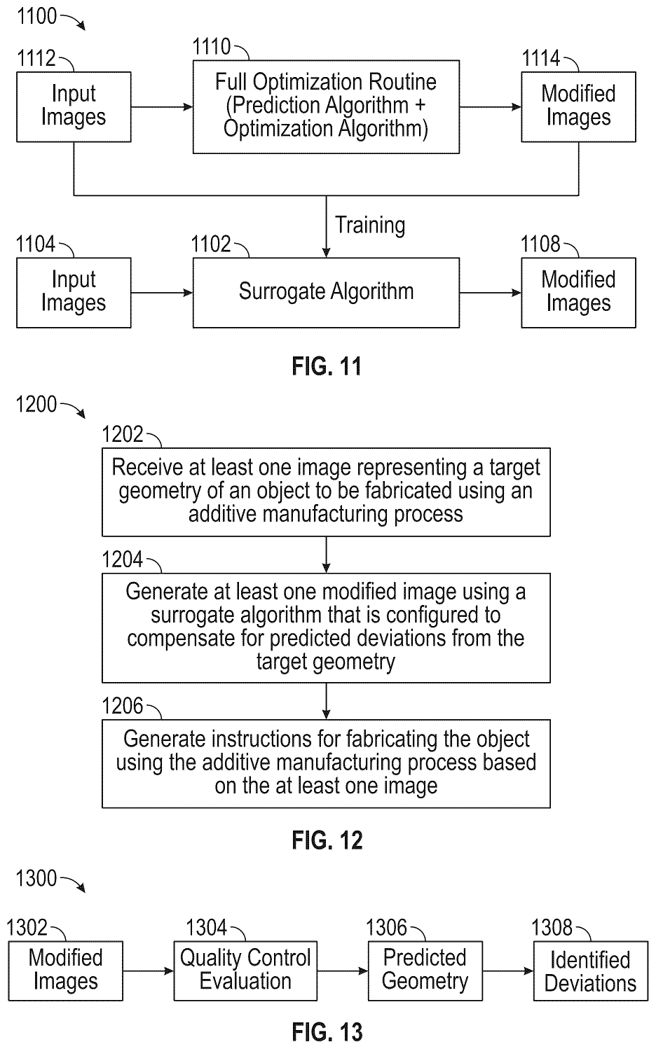

FIG. 11 is a block diagram illustrating a workflow 1100 for training a surrogate algorithm 1102, in accordance with embodiments of the present technology. The surrogate algorithm 1102 can be configured to receive one or more input images 1104 (or a tensor representing the input images 1104) representing a target geometry for an object to be fabricated via an additive manufacturing process, and to output one or more modified images 1106 (or a tensor representing the modified images 1106) that are configured to produce an object having a geometry that is more similar to the target geometry than the predicted geometry resulting from the input images 1104. The input images 1104 and modified images 1106 may be identical or generally similar to the other embodiments described herein.

In some embodiments, the surrogate algorithm 1102 is or include at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, clastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., principle component analysis (PCA), independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. For example, the surrogate algorithm 1102 can be or include a CNN, a RNN, GAN, GNN, capsule network, autoencoder, ViT, etc.

In some embodiments, the surrogate algorithm 1102 is trained using input images 1112 and modified images 1114 of a plurality of objects associated with a full optimization routine 1110. The full optimization routine 1110 can include a prediction algorithm that receives the input images 1112 for an object and determines a predicted geometry of the object after fabrication, and an optimization algorithm that generates the modified images 1114 to compensate for any deviations between the predicted and target geometry for the object. The full optimization routine 1110, including the prediction algorithm and the optimization algorithm, can be or include any of the embodiments described above with respect to FIGS. 3-10.

The input images 1112 and the corresponding modified images 1114 generated by the full optimization routine 1110 can be used as training data for the surrogate algorithm 1102. The training data can include data for any suitable number of objects, such as at least 5, 10, 20, 50, 100, 500, or 1000 objects; and/or no more 1000, 500, 100, 50, 20, 10, or 5 objects. Training can be performed using any suitable approach, such as supervised learning, unsupervised learning, or reinforcement learning. Accordingly, the surrogate algorithm 1102 can learn correlations between the input images 1112 and the corresponding modified images 1114, and thus can directly determine the appropriate modifications for a particular object geometry without requiring the complete prediction and optimization process implemented by the full optimization routine 1110. In some embodiments, the training of the surrogate algorithm 1102 penalizes outputs that results in printability issues, such as the generation of islands.

FIG. 12 is a flow diagram illustrating a method 1200 for generating instructions for additive manufacturing of an object, in accordance with embodiments of the present technology. The method 1200 can be used to produce fabrication instructions for any of the objects described herein, such one or more dental appliances. In some embodiments, some or all of the processes of the method 1200 are implemented as computer-readable instructions (e.g., program code) that are configured to be executed by one or more processors of a computing device (e.g., an appliance design system). The method 1200 can be combined with any of the other methods described herein.

The method 1200 can begin at block 1202 with receiving at least one image representing a target geometry of an object to be fabricated using an additive manufacturing process. The images can include one or more slices representing a plurality of cross-sections of the object to be fabricated via a layer-by-layer additive manufacturing process, as described herein (e.g., DLPA, SLA, SLS, inkjet). In some embodiments, the images correspond to fabrication instructions for controlling application of energy to a precursor material (e.g., resin or powder) to fabricate the object via the layer-by-layer additive manufacturing process. For example, the pixels within the image can indicate whether energy should be applied to a corresponding location in the precursor material to form a portion of the object, and, optionally, the parameters of the energy to be applied to that location (e.g., intensity, exposure time, dosage, wavelength). The images can be black and white images or grayscale images, and can be provided in any suitable file format (e.g., BMP files, PNG files).

At block 1204, the method 1200 can include generating at least one modified image using a surrogate algorithm. The surrogate algorithm can be a machine learning algorithm (e.g., a CNN) that is configured to receive the at least one image as input, and to determine one or more modifications to the at least one image that are configured to compensate for predicted deviations from the target geometry of the object when the object is fabricated via the additive manufacturing process based on the at least one image (e.g., the at least one image is used to generate fabrication instructions for implementing the additive manufacturing process). In some embodiments, the surrogate algorithm (e.g., surrogate algorithm 1102 of FIG. 11) is trained based on initial image data (e.g., input images 1112) and corresponding modified images data (e.g., modified images 1114) produced by another algorithm (e.g., full optimization routine 1110).

The modified image can include one or more modifications relative to the initial received image, such as changes the size, shape, location, and/or grayscale values of some or all of the object cross-sections represented in the image. The modifications can be configured to compensate for predicted deviations resulting from additive manufacturing and/or post-processing of the object, such as overcuring of a material used to fabricate the object, overbuild of a material used to fabricate the object, retention of a material on a surface of the object, loss of material from the object, deformation of the object, or a combination thereof.

The modified image produced by the surrogate algorithm can represent an object geometry that, when used as a basis for fabricating the object, is expected to produce improved manufacturing accuracy, such that the actual geometry of the resulting object is expected to be identical or sufficiently similar to the target geometry (e.g., there are no significant deviations between the actual geometry and the target geometry, and/or any deviations that are present do not occur at important portions of the object). In some embodiments, the modified object geometry represented in the modified image differs from the target geometry represented in the initial image, but an object fabricated based on the modified image is expected to have a geometry closer to the target geometry than an object fabricated based on the initial image.

At block 1206, the method 1200 can include generating instructions for fabricating the object using the additive manufacturing process, based on the at least one modified image produced in block 1204. The instructions can be configured to control an additive manufacturing system (e.g., an SLA, DLP, SLS, inkjet, or a hybrid printing system) to apply energy to solidify a precursor material according to the object geometry represented in the modified image. For instance, the modified image can represent locations to which energy is to be applied (and, optionally parameters for the energy application) in order to sequentially form a plurality of object cross-sections according to a layer-by-layer additive manufacturing process, as described elsewhere herein.

In some embodiments, the process of block 1206 involves converting the modified images into a format suitable for controlling the additive manufacturing system (e.g., a G-code file). Optionally, the modified image can undergo image post-processing before and/or during the conversion process. For instance, the image post-processing can include removing artifacts from the modified image (e.g., islands, spikes, holes, and/or other discontinuities), adjusting the size of the modified image (e.g., to a predetermined image length and image width), adjusting the color of the modified image (e.g., converting to black and white or grayscale), adjusting the modified image to improve printability (e.g., ensuring that the minimum feature thickness is greater than the minimum thickness for printability, increasing the thickness of the bottom layer of the object), or suitable combinations thereof. The image post-processing can also include adding components to the object geometry, such as support structures to stabilize the object during additive manufacturing and/or post-processing (e.g., struts, blocks, crossbars, etc.), identifiers for tracking the object (e.g., tags, labels, barcodes, QR codes, etc.), and so on.

Referring again to FIG. 12, the method 1200 can be modified in many different ways. For example, although the above steps of the method 1200 are described with respect to a single object, the method 1200 can be used to sequentially or concurrently generate instructions for fabricating any suitable number of objects, such as tens, hundreds, or thousands of objects. As another example, the ordering of the processes shown in FIG. 12 can be varied. Some of the processes of the method 1200 can be omitted, and/or the method 1200 can include additional processes not shown in FIG. 12. For instance, the method 1200 can additionally include displaying a graphical representation of the modified image to a user (e.g., a technician or a clinician), via a suitable display device (e.g., a monitor, screen, etc., of a computing system or device). In such embodiments, the user can provide feedback to approve the modified image or make adjustments to the modified image, if appropriate.

FIG. 13 is a flow diagram illustrating a workflow 1300 for evaluating a modified image of an object, in accordance with embodiments of the present technology. The workflow 1300 can be implemented in combination with any of the other processes described herein (e.g., in connection with the workflow 1100 of FIG. 11 and/or the method 1200 of FIG. 12).

A modified image of an object can be produced by an optimization algorithm and/or a surrogate algorithm as described herein (block 1302). The modified image can undergo a quality control evaluation (block 1304) to check for issues that may affect the accuracy and manufacturability of the object. For example, the quality control evaluation can involve evaluating whether the modified image satisfies one or more quality parameters, e.g., by detecting whether the image includes artifacts (e.g., spikes, holes), disconnected features (e.g., islands, discontinuities), insufficiently supported features, and/or features that are smaller than a minimum feature size (e.g., for printability and/or support purposes). If such issues are detected, the modified image can be adjusted to correct the issues (e.g., deleting artifacts, connecting disconnected features, adding support to insufficiently supported features, increasing the size of excessively small features, increasing the thickness of the bottom layer of the object).

Subsequently, a predicted geometry of the object after additive manufacturing based on the modified image is determined (block 1306). The predicted geometry can be determined using any of the prediction algorithms described herein. The predicted geometry can then be compared to the target geometry of the object to identify any deviations (block 1308). The identified deviations can optionally be displayed to a user, e.g., via a graphical representation (e.g., 2D image, 3D model), text, alert, or any other indication. The user can then review the identified deviations to determine whether corrective action is appropriate, such as making further adjustments to the modified image.

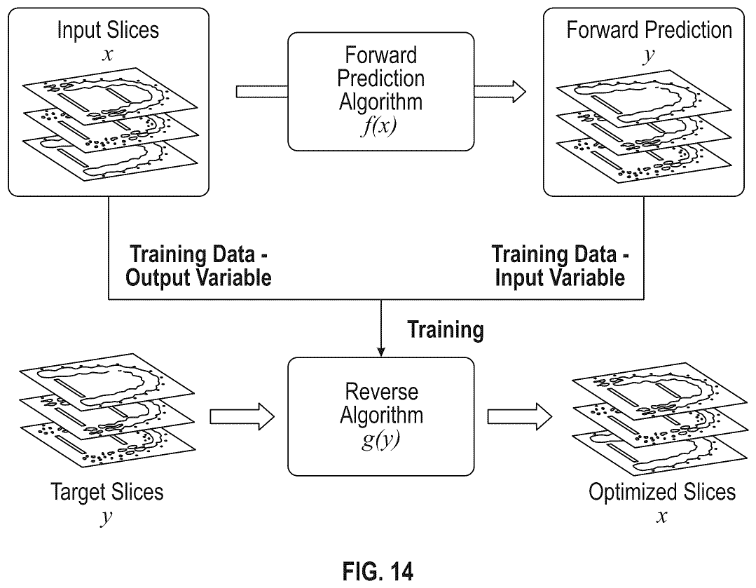

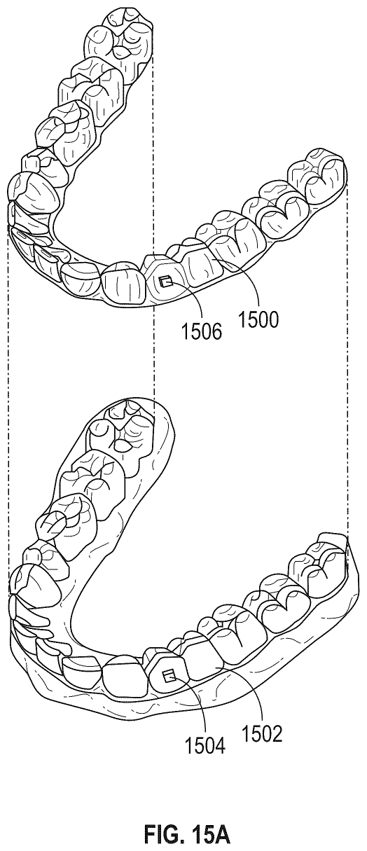

FIG. 14 is a block diagram illustrating a workflow for training a reverse algorithm, in accordance with embodiments of the present technology. In some embodiments, the present technology provides methods for determining instructions for fabricating an object with an actual geometry that conforms more closely to the target geometry, using a “reverse algorithm” that inverts the predictive relationship established by the forward prediction algorithms described herein (e.g., the prediction algorithm 502 of FIG. 5, the forward prediction model 1008 of FIG. 10). Specifically, a forward prediction algorithm can be trained to predict an output y given input image slices x, (e.g., f(x)→y). The goal of the reverse algorithm can be to reconstruct the original input image slices x given the output y predicted by the forward model, e.g., the reverse algorithm is trained to learn the mapping g(y)→x. This can be achieved by first using a forward prediction algorithm f(x)→y to generate predictions y for a dataset of known x-y pairs, then training the reverse algorithm g (y) using the forward prediction algorithm outputs y as input and the input image slices x as target outputs. In the application of this reverse algorithm, the design target, represented as the input slices, can be treated as the forward prediction result y, and the reverse algorithm can optimize the input slices to determine the appropriate image slice x for printing. Accordingly, the reverse algorithm can be considered a surrogate algorithm that may be used in place of a full optimization routine.

In some embodiments, the reverse algorithm is or include at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, clastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., principle component analysis (PCA), independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. For example, the reverse algorithm can be or include a CNN, a RNN, GAN, GNN, capsule network, autoencoder, ViT, etc.

### II. Dental Appliances and Associated Methods

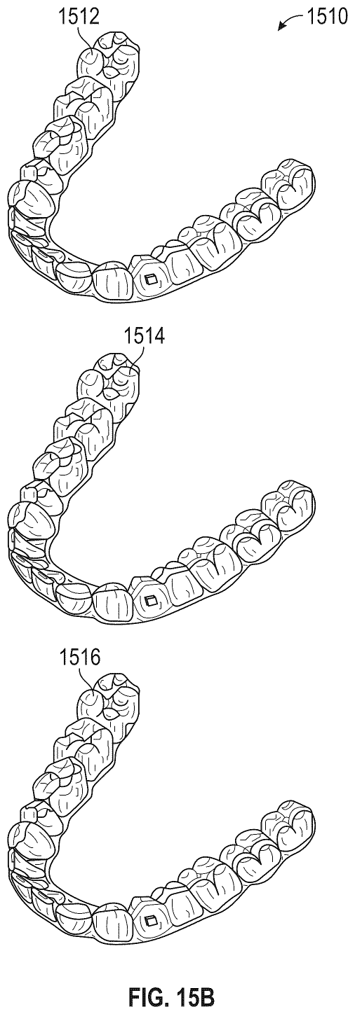

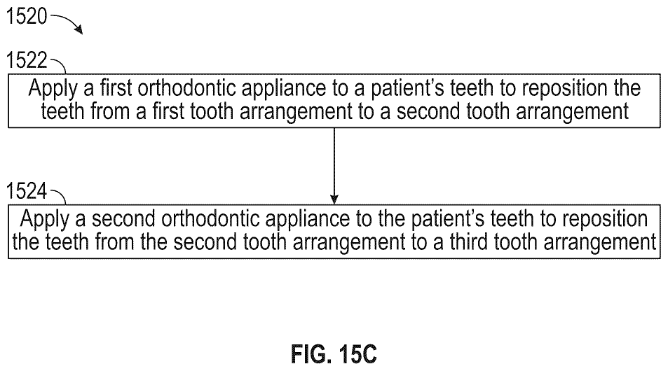

FIG. 15A illustrates a representative example of a tooth repositioning appliance 1500 configured in accordance with embodiments of the present technology. The appliance 1500 can be manufactured using any of the systems, methods, and devices described herein. The appliance 1500 (also referred to herein as an “aligner”) can be worn by a patient in order to achieve an incremental repositioning of individual teeth 1502 in the jaw. The appliance 1500 can include a shell (e.g., a continuous polymeric shell or a segmented shell) having teeth-receiving cavities that receive and resiliently reposition the teeth. The appliance 1500 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1500 can fit over all teeth present in an upper or lower jaw, or less than all of the teeth. The appliance 1500 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1500 can be a generic appliance configured to receive the teeth, but not necessarily shaped to match the topography of the patient's teeth. In some cases, only certain teeth received by the appliance 1500 are repositioned by the appliance 1500 while other teeth can provide a base or anchor region for holding the appliance 1500 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1500 in place over the teeth. In some cases, however, it may be desirable or necessary to provide individual attachments 1504 or other anchoring elements on teeth 1502 with corresponding receptacles 1506 or apertures in the appliance 1500 so that the appliance 1500 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 15B illustrates a tooth repositioning system 1510 including a plurality of appliances 1512, 1514, 1516, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1510 can include a first appliance 1512 corresponding to an initial tooth arrangement, one or more intermediate appliances 1514 corresponding to one or more intermediate arrangements, and a final appliance 1516 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 15C illustrates a method 1520 of orthodontic treatment using a plurality of appliances, in accordance with embodiments of the present technology. The method 1520 can be practiced using any of the appliances or appliance sets described herein. In block 1522, a first orthodontic appliance is applied to a patient's teeth in order to reposition the teeth from a first tooth arrangement to a second tooth arrangement. In block 1524, a second orthodontic appliance is applied to the patient's teeth in order to reposition the teeth from the second tooth arrangement to a third tooth arrangement. The method 1520 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

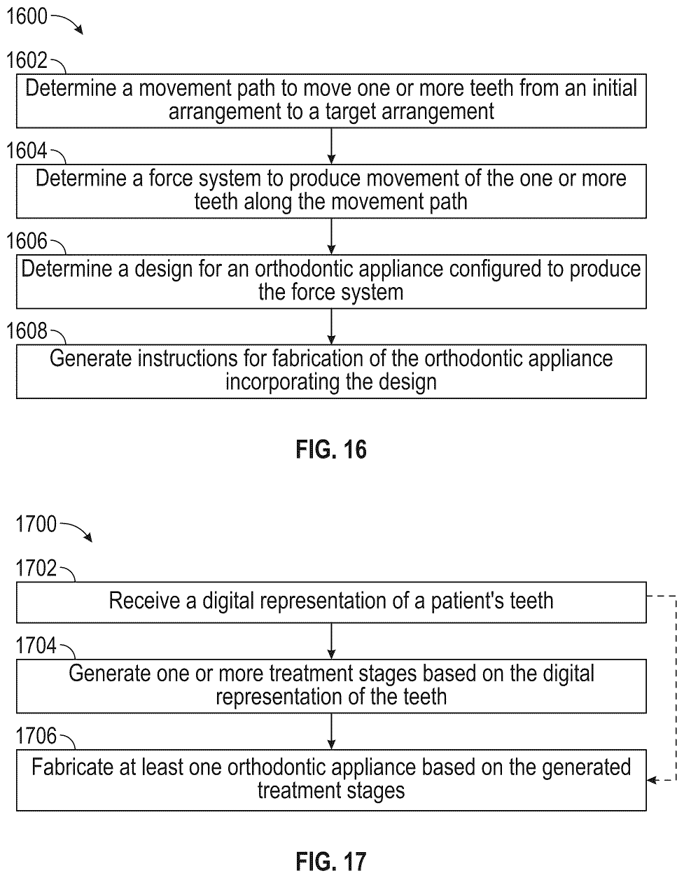

FIG. 16 illustrates a method 1600 for designing an orthodontic appliance, in accordance with embodiments of the present technology. The method 1600 can be applied to any embodiment of the orthodontic appliances described herein. Some or all of the steps of the method 1600 can be performed by any suitable data processing system or device, e.g., one or more processors configured with suitable instructions.

In block 1602, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1604, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1604 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1606, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1608, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1600 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1600 may be performed with any suitable fabrication system or device, such as the embodiments described herein. Some of the steps may be optional, e.g., the process of block 1604 can be omitted, such that the orthodontic appliance is designed based on the desired tooth movements and/or determined tooth movement path, rather than based on a force system. Moreover, the order of the steps can be varied as desired.

FIG. 17 illustrates a method 1700 for digitally planning an orthodontic treatment and/or design or fabrication of an appliance, in accordance with embodiments. The method 1700 can be applied to any of the treatment procedures described herein and can be performed by any suitable data processing system.

In block 1702, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1704, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1706, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 17, design and/or fabrication of an orthodontic appliance, and perhaps a particular orthodontic treatment, may include use of a representation of the patient's teeth (e.g., including receiving a digital representation of the patient's teeth (block 1702)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,45,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.

Example 1. A method comprising:
receiving at least one image representing a target geometry of an object to be fabricated using an additive manufacturing process;
generating at least one modified image by inputting the at least one image into a machine learning algorithm, wherein the machine learning algorithm is trained to determine one or more modifications to the at least one image, and wherein the one or modifications are configured to compensate for predicted deviations from the target geometry of the object when the object is fabricated via the additive manufacturing process based on the at least one image; and
generating instructions for fabricating the object using the additive manufacturing process, based on the at least one modified image.

Example 2. The method of Example 1, wherein the machine learning algorithm is trained on initial image data and corresponding modified image data for a plurality of additively manufactured objects.

Example 3. The method of Example 1 or 2, wherein the machine learning algorithm comprises a convolutional neural network (CNN).

Example 4. The method of any one of Examples 1 to 3, wherein the one or more modifications are configured to compensate for predicted deviations from the target geometry of the object due to the additive manufacturing process, a post-processing operation, or a combination thereof.

Example 5. The method of any one of Examples 1 to 4, wherein the one or more modifications are configured to compensate for predicted deviations from the target geometry of the object due overcuring of a material used to fabricate the object, overbuild of a material used to fabricate the object, retention of a material on a surface of the object, loss of material from the object, deformation of the object, or a combination thereof.

Example 6. The method of any one of Examples 1 to 5, wherein the one or more modifications comprise removing material from a portion of the object represented in the at least one image.

Example 7. The method of any one of Examples 1 to 6, wherein the one or more modifications comprise adding material to a portion of the object represented in the at least one image.

Example 8. The method of any one of Examples 1 to 7, wherein the additive manufacturing process comprises one or more of the following: stereolithography, digital light processing, selective laser sintering, material jetting, or material extrusion.

Example 9. The method of any one of Examples 1 to 8, wherein the additive manufacturing process comprises applying energy to a precursor material to form a plurality of object layers.

Example 10. The method of Example 9, wherein the instructions are configured to control the application of the energy to the precursor material.

Example 11. The method of Example 9 or 10, wherein the instructions are configured to cause formation of at least one object layer corresponding to the at least one modified image.

Example 12. The method of any one of Examples 1 to 11, wherein the at least one image corresponds to at least one 2D cross-section of a 3D digital representation of the object.

Example 13. The method of any one of Examples 1 to 12, further comprising determining a predicted geometry of the object after fabrication using the additive manufacturing process, based on the at least one modified image.

Example 14. The method of Example 13, further comprising identifying a deviation between the target geometry and the predicted geometry.

Example 15. The method of Example 14, further comprising outputting an indication of the identified deviation.

Example 16. The method of any one of Examples 1 to 15, further comprising evaluating whether the at least one modified image satisfies one or more quality control parameters.

Example 17. The method of Example 16, wherein the evaluating comprises detecting artifacts, detecting disconnected features, detecting insufficiently supported features, detecting features smaller than a minimum feature size, or a combination thereof.

Example 18. The method of Example 16 or 17, further comprising adjusting the at least one modified image in response to an evaluation that the at least one modified image does not satisfy the one or more quality control parameters.

Example 19. The method of any one of Examples 1 to 18, wherein the at least one modified image represents a modified geometry for the object that differs from the target geometry.

Example 20. The method of any one of Examples 1 to 19, further comprising fabricating the object using the additive manufacturing process, based on the instructions.

Example 21. A system comprising:
one or more processors; and
a memory operably coupled to the one or more processors and storing instructions that, when executed by the one or more processors, cause the system to perform operations comprising:
   receiving at least one image representing a target geometry of an object to be fabricated using an additive manufacturing process,
   generating at least one modified image by inputting the at least one image into a machine learning algorithm, wherein the machine learning algorithm is trained to determine one or more modifications to the at least one image, and wherein the one or modifications are configured to compensate for predicted deviations from the target geometry of the object when the object is fabricated via the additive manufacturing process based on the at least one image, and
   generating instructions for fabricating the object using the additive manufacturing process, based on the at least one modified image.

Example 22. The system of Example 21, wherein the machine learning algorithm is trained on initial image data and corresponding modified image data for a plurality of additively manufactured objects.

Example 23. The system of Example 21 or 22, wherein the machine learning algorithm comprises a convolutional neural network (CNN).

Example 24. The system of any one of Examples 21 to 23, wherein the one or more modifications are configured to compensate for predicted deviations from the target geometry of the object due to the additive manufacturing process, a post-processing operation, or a combination thereof.

Example 25. The system of any one of Examples 21 to 24, wherein the one or more modifications are configured to compensate for predicted deviations from the target geometry of the object due overcuring of a material used to fabricate the object, overbuild of a material used to fabricate the object, retention of a material on a surface of the object, loss of material from the object, deformation of the object, or a combination thereof.

Example 26. The system of any one of Examples 21 to 25, wherein the one or more modifications comprise removing material from a portion of the object represented in the at least one image.

Example 27. The system of any one of Examples 21 to 26, wherein the one or more modifications comprise adding material to a portion of the object represented in the at least one image.

Example 28. The system of any one of Examples 21 to 27, wherein the additive manufacturing process comprises one or more of the following: stereolithography, digital light processing, selective laser sintering, material jetting, or material extrusion.

Example 29. The system of any one of Examples 21 to 28, wherein the additive manufacturing process comprises applying energy to a precursor material to form a plurality of object layers.

Example 30. The system of Example 29, wherein the instructions are configured to control the application of the energy to the precursor material.

Example 31. The system of Example 29 or 30, wherein the instructions are configured to cause formation of at least one object layer corresponding to the at least one modified image.

Example 32. The system of any one of Examples 21 to 31, wherein the at least one image corresponds to at least one 2D cross-section of a 3D digital representation of the object.

Example 33. The system of any one of Examples 21 to 32, further comprising determining a predicted geometry of the object after fabrication using the additive manufacturing process, based on the at least one modified image.

Example 34. The system of Example 33, further comprising identifying a deviation between the target geometry and the predicted geometry.

Example 35. The system of Example 34, further comprising outputting an indication of the identified deviation.

Example 36. The system of any one of Examples 21 to 35, further comprising evaluating whether the at least one modified image satisfies one or more quality control parameters.

Example 37. The system of Example 36, wherein the evaluating comprises detecting artifacts, detecting disconnected features, detecting insufficiently supported features, detecting features smaller than a minimum feature size, or a combination thereof.

Example 38. The system of Example 36 or 37, further comprising adjusting the at least one modified image in response to an evaluation that the at least one modified image does not satisfy the one or more quality control parameters.

Example 39. The system of any one of Examples 21 to 38, wherein the at least one modified image represents a modified geometry for the object that differs from the target geometry.

Example 40. The system of any one of Examples 21 to 39, further comprising fabricating the object using the additive manufacturing process, based on the instructions.

Example 41. A method comprising:
receiving at least one image representing a target geometry of an object to be fabricated using an additive manufacturing process;
determining a predicted geometry of the object after fabrication using the additive manufacturing process, based on the at least one image;
identifying a deviation between the target geometry and the predicted geometry;
modifying the at least one image based on the identified deviation; and
generating instructions for fabricating the object using the additive manufacturing process, based on the at least one modified image.

Example 42. The method of Example 41, wherein the prediction is determined using a machine learning algorithm.

Example 43. The method of Example 42, wherein the machine learning algorithm comprises a convolutional neural network (CNN).

Example 44. The method of Example 43, wherein the CNN is trained using images of other objects fabricated using the additive manufacturing process.

Example 45. The method of Example 43 or 44, wherein the CNN comprises a kernel, and wherein the kernel comprises a function representing a physical or chemical phenomenon associated with the additive manufacturing process.

Example 46. The method of Example 45, wherein the physical or chemical phenomenon comprises light scattering.

Example 47. The method of any one of Examples 42 to 46, wherein the machine learning algorithm is configured to predict deviations from the target geometry of the object due to the additive manufacturing process, a post-processing operation, or a combination thereof.

Example 48. The method of any one of Examples 42 to 47, wherein the machine learning algorithm is configured to predict deviations from the target geometry of the object due to overcuring of a material used to fabricate the object, overbuild of a material used to fabricate the object, retention of a material on a surface of the object, loss of material from the object, deformation of the object, or a combination thereof.

Example 49. The method of any one of Examples 41 to 48, wherein the additive manufacturing process comprises one or more of the following: stereolithography, digital light processing, selective laser sintering, material jetting, or material extrusion.

Example 50. The method of any one of Examples 41 to 49, wherein the additive manufacturing process comprises applying energy to a precursor material to form a plurality of object layers.

Example 51. The method of Example 50, wherein the instructions are configured to control the application of the energy to the precursor material.

Example 52. The method of Example 50 or 51, wherein the instructions are configured to cause formation of at least one object layer corresponding to the at least one modified image.

Example 53. The method of any one of Examples 41 to 52, wherein the predicted geometry represents a geometry of the object after fabrication using the additive manufacturing process and after undergoing a post-processing operation.

Example 54. The method of Example 53, wherein the post-processing operation comprises one or more of centrifuging the object, post-curing the object, or washing the object.

Example 55. The method of any one of Examples 41 to 54, wherein the at least one image corresponds to at least one 2D cross-section of a 3D digital representation of the object.

Example 56. The method of any one of Examples 41 to 55, wherein the modifying is performed using an optimization algorithm.

Example 57. The method of Example 56, wherein the optimization algorithm is an inverse optimization algorithm.

Example 58. The method of any one of Examples 41 to 57, further comprising generating at least one second image representing the predicted geometry of the object.

Example 59. The method of Example 58, wherein the deviation is identified based on the at least one image and the at least one second image.

Example 60. The method of Example 59, wherein the deviation is identified by comparing the at least one image to the at least one second image.

Example 61. The method of any one of Examples 41 to 60, wherein the object comprises a dental appliance.

Example 62. The method of Example 61, wherein the dental appliance is an aligner, palatal expander, retainer, attachment placement device, or mouth guard.

Example 63. A system comprising:
one or more processors; and
a memory operably coupled to the one or more processors and storing instructions that, when executed by the one or more processors, cause the system to perform operations comprising:
   receiving at least one image representing a target geometry of an object to be fabricated using an additive manufacturing process,
   determining a predicted geometry of the object after fabrication using the additive manufacturing process, based on the at least one first image,
   identifying a deviation between the target geometry and the predicted geometry,
   modifying the at least one image based on the identified deviation, and
   generating instructions for fabricating the object using the additive manufacturing process, based on the at least one modified image.

Example 64. The system of Example 63, wherein the at least one second image is generated using a machine learning algorithm.

Example 65. The system of Example 64, wherein the machine learning algorithm comprises a convolutional neural network (CNN).

Example 66. The system of Example 65, wherein the CNN is trained using images of other objects fabricated using the additive manufacturing process.

Example 67. The system of Example 65 or 66, wherein the CNN comprises a kernel, and wherein the kernel comprises a function representing a physical or chemical phenomenon associated with the additive manufacturing process.

Example 68. The system of Example 67, wherein the physical or chemical phenomenon comprises light scattering.

Example 69. The system of any one of Examples 64 to 68, wherein the machine learning algorithm is configured to predict deviations from the target geometry of the object due to the additive manufacturing process, a post-processing operation, or a combination thereof.

Example 70. The system of any one of Examples 64 to 69, wherein the machine learning algorithm is configured to predict deviations from the target geometry of the object due to overcuring of a material used to fabricate the object, overbuild of a material used to fabricate the object, retention of a material on a surface of the object, loss of material from the object, deformation of the object, or a combination thereof.

Example 71. The system of any one of Examples 63 to 70, wherein the additive manufacturing process comprises one or more of the following: stereolithography, digital light processing, selective laser sintering, material jetting, or material extrusion.

Example 72. The system of any one of Examples 63 to 71, wherein the additive manufacturing process comprises applying energy to a precursor material to form a plurality of object layers.

Example 73. The system of Example 72, wherein the instructions are configured to control the application of the energy to the precursor material.

Example 74. The system of Example 72 or 73, wherein the instructions are configured to cause formation of at least one object layer corresponding to the at least one modified image.

Example 75. The system of any one of Examples 72 to 74, further comprising an additive manufacturing system, wherein the additive manufacturing system comprises:
an energy source configured to output the energy,
a source of the precursor material, and
a controller configured to cause the energy source to apply the energy to the precursor material in accordance with the instructions.

Example 76. The system of any one of Examples 63 to 75, wherein the predicted geometry represents a geometry of the object after fabrication using the additive manufacturing process and after undergoing a post-processing operation.

Example 77. The system of Example 76, wherein the post-processing operation comprises one or more of centrifuging the object, post-curing the object, or washing the object.

Example 78. The system of any one of Examples 63 to 77, wherein the at least one image corresponds to at least one 2D cross-section of a 3D digital representation of the object.

Example 79. The system of any one of Examples 63 to 78, wherein the modifying is performed using an optimization algorithm.

Example 80. The system of Example 79, wherein the optimization algorithm is an inverse optimization algorithm.

Example 81. The system of any one of Examples 63 to 80, wherein the operations further comprise generating at least one second image representing the predicted geometry of the object.

Example 82. The system of Example 81, wherein the deviation is identified based on the at least one image and the at least one second image.

Example 83. The system of Example 82, wherein the deviation is identified by comparing the at least one image to the at least one second image.

Example 84. The system of any one of Examples 63 to 83, wherein the object comprises a dental appliance.

Example 85. The system of Example 84, wherein the dental appliance is an aligner, palatal expander, retainer, attachment placement device, or mouth guard.

Example 86. A non-transitory computer-readable storage medium comprising instructions that, when executed by one or more processors of a computing system, cause the computing system to perform operations comprising:
receiving at least one image representing a target geometry of an object to be fabricated using an additive manufacturing process;
generating a predicted geometry of the object after fabrication using the additive manufacturing process, based on the at least one image;
identifying a deviation between the target geometry and the predicted geometry;
modifying the at least one image based on the identified deviation; and
generating instructions for fabricating the object using the additive manufacturing process, based on the at least one modified image.

### CONCLUSION

Although many of the embodiments are described above with respect to systems, devices, and methods for manufacturing dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-17.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving at least one image representing a target geometry of an object to be fabricated using an additive manufacturing process;
generating at least one modified image by inputting the at least one image into a machine learning algorithm, wherein the machine learning algorithm is trained to determine one or more modifications to the at least one image, and wherein the one or modifications are configured to compensate for predicted deviations from the target geometry of the object when the object is fabricated via the additive manufacturing process based on the at least one image; and
generating instructions for fabricating the object using the additive manufacturing process, based on the at least one modified image.

2. The method of claim 1, wherein the machine learning algorithm is trained on initial image data and corresponding modified image data for a plurality of additively manufactured objects.

3. The method of claim 1, wherein the machine learning algorithm comprises a convolutional neural network (CNN).

4. The method of claim 1, wherein the one or more modifications are configured to compensate for predicted deviations from the target geometry of the object due to the additive manufacturing process, a post-processing operation, or a combination thereof.

5. The method of claim 1, wherein the one or more modifications are configured to compensate for predicted deviations from the target geometry of the object due overcuring of a material used to fabricate the object, overbuild of a material used to fabricate the object, retention of a material on a surface of the object, loss of material from the object, deformation of the object, or a combination thereof.

6. The method of claim 1, wherein the one or more modifications comprise removing material from a portion of the object represented in the at least one image.

7. The method of claim 1, wherein the one or more modifications comprise adding material to a portion of the object represented in the at least one image.

8. The method of claim 1, wherein the additive manufacturing process comprises one or more of the following: stereolithography, digital light processing, selective laser sintering, material jetting, or material extrusion.

9. The method of claim 1, wherein the additive manufacturing process comprises applying energy to a precursor material to form a plurality of object layers.

10. The method of claim 9, wherein the instructions are configured to control the application of the energy to the precursor material.

11. The method of claim 9, wherein the instructions are configured to cause formation of at least one object layer corresponding to the at least one modified image.

12. The method of claim 1, wherein the at least one image corresponds to at least one 2D cross-section of a 3D digital representation of the object.

13. The method of claim 1, further comprising determining a predicted geometry of the object after fabrication using the additive manufacturing process, based on the at least one modified image.

14. The method of claim 13, further comprising identifying a deviation between the target geometry and the predicted geometry.

15. The method of claim 14, further comprising outputting an indication of the identified deviation.

16. The method of claim 1, further comprising evaluating whether the at least one modified image satisfies one or more quality control parameters.

17. The method of claim 16, wherein the evaluating comprises detecting artifacts, detecting disconnected features, detecting insufficiently supported features, detecting features smaller than a minimum feature size, or a combination thereof.

18. The method of claim 16, further comprising adjusting the at least one modified image in response to an evaluation that the at least one modified image does not satisfy the one or more quality control parameters.

19. The method of claim 1, wherein the at least one modified image represents a modified geometry for the object that differs from the target geometry.

20. The method of claim 1, further comprising fabricating the object using the additive manufacturing process, based on the instructions.
